(19) United States
(12) Patent Application Publication
(10) Pub. No.: US 2023/0256397 A1
(43) Pub. Date: Aug. 17, 2023

(54) DUAL-LAYER MEMBRANE

(71) Applicant: COMMONWEALTH SCIENTIFIC AND INDUSTRIAL RESEARCH ORGANISATION, Acton, Australian Capital Territory (AU)

(72) Inventors: Zongli Xie, Acton, Australian Capital Territory (AU); Stephen Richard Gray, Footscray, Victoria (AU); Guang Yang, Clayton, Victoria (AU)

(21) Appl. No.: 18/012,214

(22) PCT Filed: Jun. 18, 2021
(86) PCT No.: PCT/AU2021/050635

§ 371 Date: Dec. 21, 2022

(30) Foreign Application Priority Data
Jun. 23, 2020 (AU) 2020902089

(51) Int. Cl. B01D 69/02; B01D 71/38; B01D 69/10; B01D 67/00; B01D 61/02; B01D 61/36; B01D 71/02; C02F 1/44; B01D 69/14

(52) U.S. Cl. CPC B01D 69/02; B01D 71/381; B01D 69/107; B01D 67/0079; B01D 61/025; B01D 61/362; B01D 61/364; B01D 71/0212; B01D 71/028; B01D 71/0211; C02F 1/448; C02F 1/447; B01D 69/148; C02F 1/441; B01D 2325/36; B01D 2325/02832; B01D 2325/02831; B01D 2325/04; B01D 2323/30; B01D 2323/02; B01D 2323/06; B01D 2323/12; B01D 2323/21; B01D 2323/60; B01D 2323/081; C02F 2103/08

(57) ABSTRACT

The present disclosure generally relates to liquid separation membranes. The present disclosure also relates to membranes comprising at least a nanoporous hydrophilic layer and a porous hydrophobic substrate. The present disclosure also relates to a process for preparing the membranes and to use of the membranes in pervaporation and/or membrane distillation processes including desalination and/or solvent dehydration.

### FIELD

The present disclosure generally relates to liquid separation membranes. The present disclosure also relates to membranes comprising at least a nanoporous hydrophilic layer and a porous hydrophobic substrate. The present disclosure also relates to a process for preparing the membranes and to use of the membranes in pervaporation and/or membrane distillation processes including desalination and/or solvent dehydration.

### BACKGROUND

Pervaporation (PV) and membrane distillation (MD) are established membrane separation processes driven by partial vapour difference however using different types of membranes.

Typically, the pervaporation process combines the evaporation of volatile components of a mixture with their permeation through a nonporous polymeric membrane under reduced pressure conditions. During pervaporation for desalination or solvent dehydration, the feed mixture is in direct contact with one side of the hydrophilic membrane and the permeate is removed in a vapour state from the permeate side. Transport through the membrane is driven by the vapour pressure difference between the feed solution and the permeate vapour. The vapour pressure difference is generally created by applying a vacuum or by sweeping an inert gas on the permeate side of the membrane.

Similarly, MD is a thermally-driven separation process that is typically used for desalination. In MD, vapour molecules evaporate from the feed solution and are transported through micron-dimension pores (often ranging from 0.1 to 1 μm) of hydrophobic membranes as permeate. The driving force in the MD process is the vapour pressure difference induced by the temperature difference across the membrane. For the MD process, it is essential that liquid water does not pass through the pores. In this sense, the role of membranes is different from other membrane processes since it acts as a physical support for the liquid-vapour interface. It has been observed that the hydrophobicity of MD membranes may decrease resulting in the reduction of permeate flux and the loss of salt rejection due to the wetting of membrane surface during prolonged use.

The current utilization in industry is multi-stage PV or combined process with distillation. One of the key causes impeding its further extension to standalone application or complete substitution of conventional distillation is the lack of membranes with outstanding permeability, selectivity and stability during operation.

Therefore, there is a need for alternative or improved membranes that can provide various desirable properties such as processability, perm-selectivity, formation and transport properties for the separation of water from aqueous mixtures.

### SUMMARY

The present disclosure provides membranes comprising a thin nanoporous hydrophilic layer and a porous hydrophobic support. The membranes can be used for the separation of liquid mixtures, such as the separation of water from aqueous mixtures.

In one aspect, there is provided a membrane comprising a nanoporous hydrophilic layer supported on a porous hydrophobic substrate, wherein the pore size of the hydrophilic layer may be less than about 10 nm. The nanoporous hydrophilic layer may comprise a hydrophilic polymer. The nanoporous hydrophilic layer may further comprise a crosslinking agent. The nanoporous hydrophilic layer may further comprise a nanofiller. The membrane may comprise or consist a nanoporous hydrophilic layer comprising a hydrophilic polymer, optionally one or more crosslinking agents, and optionally one or more nanofillers, wherein the nanoporous hydrophilic layer supported on a porous hydrophobic substrate.

In another aspect, there is provided a process for preparing a membrane comprising a nanoporous hydrophilic layer supported on a porous hydrophobic substrate, the process comprising the steps of: (i) preparing a hydrophilic casting solution comprising a hydrophilic polymer, optionally a crosslinking agent, optionally a nanofiller, and a solvent system; (ii) casting a layer of the hydrophilic casting solution onto a porous hydrophobic substrate to provide a wet hydrophilic layer supported on the porous hydrophobic substrate. The process may further comprise step (iii) solidifying the wet hydrophilic layer by (a) solvent evaporation and/or (b) heat treatment to provide a dry hydrophilic layer supported on the porous hydrophobic substrate.

In another aspect, there is provided a membrane comprising a nanoporous hydrophilic layer supported on a porous hydrophobic substrate prepared by the process as defined by any one of the embodiments or examples as described herein.

In another aspect, there is provided a use of a membrane according to any embodiments or examples thereof as described herein for separation of water from aqueous-ion mixtures.

In another aspect, there is provided a use of a membrane according to any embodiments or examples thereof as described herein for separation of water from alcohol mixtures.

In another aspect, there is provided a use of a membrane according to any embodiments or examples thereof as described herein in combination with reverse osmosis treatment.

### BRIEF DESCRIPTION OF DRAWINGS

Preferred embodiments of the present disclosure will be further described and illustrated, by way of example only, with reference to the accompanying drawings in which:

FIG. 1 shows a schematic diagram of the fabrication of intrusion-free composite membrane and the nanoporous hydrophilic layer formation process: (a) stereoscopic description of the composite membrane fabrication process (arrows represent manually controlled manipulations as numbered in sequence); (b) Cassie-Baxter state of the casting solution on porous PTFE hydrophobic substrate and the following separating layer formation process via water evaporation.

FIG. 2 is a FESEM cross-sectional morphologies of the PVA based nanoporous hydrophilic layers (similar thicknesses) on a porous hydrophobic substrate compared with various hydrophilic substrates; a) porous hydrophobic substrate, PTFE, showing an intrusion-free layer; b) PES hydrophilic substrate (average pore size of 0.1 μm); c) nylon hydrophilic substrate (average pore size of 0.22 μm); d) CA hydrophilic substrate (average pore size of 1 μm).

FIG. 3 is a series of images and graphs showing (a) TEM image of several as-prepared Ti₃C₂Tₓ MXene nanosheets with the lateral diameters in the range of 142±90 nm; (b) SEM surface view of the PSM/PTFE dual-layer membrane; (c) cross-sectional image of the dual-layer membrane, confirming the PVA based nanoporous hydrophilic layer thickness of ≈230 nm; (d) the surface EDS elemental mapping corresponding to the PSM/PFTE dual-layer membrane with uniform C, O, S and Tᵢ distribution; (e) EDS line scan across the cross-section of the PSM layer; (f) photograph of large-scale PSM/PTFE dual-layer membrane with magnified section (inserted) showing a thin nanoporous hydrophilic layer on top of the porous hydrophobic substrate.

FIG. 4 is an interfacial adhesion and stability test.

FIG. 5 is a schematic drawing of a pervaporation unit.

FIG. 6 is a separation performance graph of the synthesized dual-layer membranes.

FIG. 7 is a graph showing 50 h long-term desalination of 0.6 M NaCl solution at 30° C.; (a) PVA/PTFE; (b) PS/PTFE and (c) PSM/PTFE.

FIG. 8 is a graph showing separation performances of PSM/PTFE for (a) PV desalination and (b) solvent dehydration.

FIG. 9 is a graph showing 50 h long-term ethanol dehydration by PSM/PTFE membrane.

FIG. 10 is a comparison of the pervaporation desalination performance under similar conditions (0.6 M NaCl as feed, 30° C., 130 Pa), (b) comparison of ethanol dehydration performance of different kinds of membranes (PVA based, CS based, SA based, GO based and MXene membrane).

FIG. 11 is (a) PV performance comparison between PM/PTFE, PS/PTFE and PSA4/PTFE (5 wt % ACNT) at 30° C. and 130 Pa vacuum pressure, and (b) proposed CNT mediated transport mechanism (red spots represent sulfonic acid groups); diffusion neat polymer phase (orange arrow), fast diffusion through CNT nanochannel (red arrow) and diffusion along CNT surface (green arrow).

FIG. 12 is (a) PV performance comparison between PSC/PTFE, PSA2/PTFE, PSA4/PTFE and PSA6/PTFE (30° C., 130 Pa and 35,000 ppm NaCl solution), and (b) effect of ACNT contents on separation performance of PSA4/PTFE.

FIG. 13 is (a) 50 h long-term performance of PSA4/PTFE (30° C., 130 Pa and 35,000 ppm NaCl solution), and (b) comparison of PV desalination performance of PSA4/PTFE and PSA6/PTFE with typical membranes.

FIG. 14 is a schematic of a direct contact membrane distillation (DCMD) setup.

FIG. 15 is a graph showing the effect on permeation flux when the thickness of a nanoporous hydrophilic layer(s) is varied on a porous hydrophobic substrate.

FIG. 16 is a graph showing the effect on permeation flux when the concentration of nanofiller is varied in a nanoporous hydrophilic layer(s) supported by a porous hydrophobic substrate.

FIG. 17 is a graph showing the water contact angles of the PTFE and dual-layer membranes.

FIG. 18 is a graph showing water vapor flux of the dual-layer membranes (a) and electro-conductivity in the permeate side (b) at different water recovery degrees.

FIG. 19 is a graph showing (a) water vapor flux of the bare PTFE dual-layer membranes (1% AlFu-MOF loading) using feed solution containing NaCl (35000 ppm) and SDS (0.4 mM); (b) corresponding EC in the permeate.

FIG. 20 is a schematic illustration of (a) PTFE and (b) PTFE-PSA-1 membranes in DCMD process with an SDS-containing feed solution.

FIG. 21 is a graph showing liquid entry pressure (LEP) comparison with SDS and without SDS in the solution (0.4 mM) of the dual-layer membranes.

FIG. 22 is a graph showing Real seawater direct contact membrane distillation (DCMD) at 40° C. of feed and 10° C. of the permeate;(a) performance of PTFE membrane and (b) performance of PTFE-PSA-1 membrane.

### DETAILED DESCRIPTION

The present disclosure describes the following various non-limiting examples, which relate to investigations undertaken to identify alternative and improved membranes, and to any methods of making and use thereof.

### General Definitions and Terms

In the following description, reference is made to the accompanying drawings which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 5, 5.5 and 6, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of” is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Herein the term “about” encompasses a 10% tolerance in any value or values connected to the term.

Herein the term “weight %” may be abbreviated to as “wt %”.

### Dual-Layer Membrane

Typically liquid separation membranes (e.g. desalination membranes) have been of asymmetric thin layer composite construction with a dense hydrophilic layer attached on an underlying microporous hydrophilic membrane support. Reducing the intrinsic membrane thickness may increase permeation flux but obtaining a scalable and ultrathin hydrophilic layer while maintaining its defect-free coverage on the underneath support remains technically challenging. Previously polyamide hydrophilic layers of thickness down to one hundred nanometers, for example, have been used as desalination membranes and the thickness typically controlled by interfacial polymerization, however this level of membrane thickness free of defects is difficult to obtain using scalable processes (e.g. solution casting) and shortcomings such as solvent penetration into the hydrophilic microporous support layer is unavoidable. Polyvinyl acetate (PVA) is solution-processable and its hybrid separating layer can be approximately 3-20 μm thick by solution casting or spin coating. Extensive research efforts have been devoted to improving the perm-selectivity, formation and transport properties of the ultrathin PVA based layer, which are evidently influenced by the surface properties and pore structures of the substrate. It has been found intrusion of casting solution into pores exerts augmented mass transport resistance due to the elongated permeation path and it is unavoidable for an aqueous hydrophilic polymer solution to penetrate into the hydrophilic support layer. Shrinking the pore sizes of prevailing polysulfone (PSf), polyethersulfone (PES) and polyacrylonitrile (PAN) type hydrophilic support substrates to several tens of nanometers was found to restrain the intrusion, but that increases the overall transport resistance. By contrast, hydrophobic support substrates were found to reject the penetration during membrane casting, providing a potential means to forming a well-aligned layer thereon.

The present disclosure is directed to providing improvements in perm selective membranes for pervaporation separation. The present disclosure covers extensive research and development directed to identifying materials that can act as a nanoporous hydrophilic layer supported by a porous hydrophobic substrate to provide outstanding separation performance with high throughput.

The inventors have surprisingly found that a dual-layer membrane comprising a nanoporous hydrophilic layer supported on a porous hydrophobic substrate provides a highly selective membrane capable of separating water from aqueous mixtures. In at least some embodiments or examples the membranes may be substantially free of defects or intrusions.

It has also been found that the membranes, at least according to some embodiments or examples as described herein, may provide one or more advantages such as:

(a) long term stability;

(b) substantially free of defects or intrusions;

(c) ultrathin nanoporous hydrophilic layer; and/or

(d) improved water permeation.

In some embodiments or examples, the present disclosure provides a membrane comprising or consisting of a nanoporous hydrophilic layer supported on a porous hydrophobic substrate. In some embodiments or examples, the present disclosure may also provide a membrane comprising or consisting of a nanoporous hydrophilic layer comprising a hydrophilic polymer, optionally one or more crosslinking agents, and optionally one or more nanofillers, wherein the nanoporous hydrophilic layer supported on a porous hydrophobic substrate. In at least some other embodiments or examples, the membrane is capable of separating water from aqueous mixtures. In some embodiments or examples, the membrane is for pervaporating or distilling mixtures. In some embodiments or examples, the membrane is for use in pervaporating liquids. In some embodiments or examples, the membrane is for use in pervaporation and/or membrane distillation processes.

### Composition of the Dual Layer Membrane

In some embodiments or examples, the membrane as described herein may comprise a nanoporous hydrophilic layer supported on a porous hydrophobic substrate. The membrane as described herein may consist of a nanoporous hydrophilic layer supported on a porous hydrophobic substrate, wherein the nanoporous hydrophilic layer comprises or consists of a hydrophilic polymer, optionally one or more crosslinkers, and optionally one or more nanofillers. In some embodiments or examples, the nanoporous hydrophilic layer may comprise or consist of a water soluble polymer, a crosslinking agent, and optionally one or more nanofillers. In some embodiments or examples, the nanoporous hydrophilic layer comprises or consists of a water soluble polymer, a sulphonated crosslinking agent, and optionally one or more nanofillers. In some embodiments or examples, the nanoporous hydrophilic layer comprises or consists of a water soluble polymer, a sulphonated crosslinking agent, and a nanofiller. In some embodiments or examples, the nanoporous hydrophilic layer comprises or consists of a water soluble polymer, a sulphonated crosslinking agent, and one or more nanofillers selected from the group comprising MXene, carbon-based nanomaterials, MOFs, and silica nanoparticles. For example, the hydrophilic layer may comprise or consist of a polyvinyl alcohol, a sulphonated crosslinking agent, and a nanofiller. For example, the hydrophilic layer may comprise or consist of a polyvinyl alcohol, a sulphonated crosslinking agent, and a MXene. In another example, the hydrophilic layer may comprise or consist of a polyvinyl alcohol, a sulphonated crosslinking agent, and a carbon-based nanomaterial.

The nanoporous hydrophilic layer may be provided on a porous hydrophobic support substrate. This means that the hydrophilic layer may be physically supported by the porous hydrophobic substrate, but does not impose any limitation on the position, shape or configuration of the porous hydrophobic substrates relative to the position, shape or configuration of the hydrophilic layer. Thus, the porous hydrophobic substrate may be provided on one side of the hydrophilic layer, this being the “top” or “bottom” side, or indeed there may be more than one porous hydrophobic substrate associated with the hydrophilic layer, in which case the porous hydrophobic substrates may be disposed on different sides of the hydrophilic layer or they may be on the same side. There may also be provided more than one hydrophilic layer. It will be appreciated that use of the term “dual-layer” in relation to the membranes as described herein does not limit the present disclosure to providing some embodiments or examples with additional layers to a first hydrophilic layer being provided on a first hydrophobic substrate. For example, second or subsequent hydrophilic layers or hydrophobic layers, or other layers may be provided. In some embodiments or examples, the porous hydrophobic support substrate may comprise a hydrophobic composite layer. The porous hydrophobic support substrate may comprise two or more hydrophobic composite layers. The composite layer may comprise one or more hydrophobic polymeric materials within a polymeric matrix, wherein the hydrophobic polymeric materials may be dispersed fibres within the polymeric matrix.

### Nanoporous Hydrophilic Layer

The nanoporous hydrophilic layer can be supported on a porous hydrophobic substrate. The hydrophilic layer may comprise a hydrophilic polymer, optionally one or more crosslinkers, and optionally one or more nanofillers.

In some embodiments or examples, the nanoporous hydrophilic layer may have a pore size in the range of about 0.1 nm to about 10 nm. In some embodiments or examples, the nanoporous hydrophilic layer may have a pore size in the range of about 0.3 nm to about 5 nm. The pore size (nm) may be less than about 10, 9, 8, 7, 6, 5, 4, 3, 2, 1, 0.9, 0.8, 0.7, 0.6, 0.5, 0.4, 0.3, 0.2 or 0.1. The pore size (nm) may be at least about 0.1, 0.2, 0.3, 0.4, 0.5, 0.6, 0.7, 0.8, 0.9, 1, 2, 3, 4, 5, 6, 7, 8, 9 or 10. The pore size of the nanoporous hydrophilic layer may be in a range provided by any two of these upper and/or lower amounts. In one example, the pore size of the nanoporous hydrophilic layer may be less than 10 nm. In another example, the pore size of the nanoporous hydrophilic layer may be less than 5 nm. In an example, the pore size of the nanoporous hydrophilic layer may be less than 1 nm. For example, the pore size of the nanoporous hydrophilic layer may in a range of about 0.3 nm to about 0.5 nm.

In some embodiments or example, the nanoporous hydrophilic layer may have a pore dimension in the range of about 0.1 nm and 10 nm. The pore dimension (nm) may be less than 10, 8, 6, 4, 2, 1.8, 1.6, 1.4, 1.2, 1, 0.5, or 0.1. The pore dimension (nm) may be at least 0.1, 0.5, 1, 1.2, 1.3, 1.4, 1.5, 1.6, 1.7, 1.8, 1.9, 2, 2.2, 2.4, 2.5, 5, 7, 9, or 10.

In some embodiments or examples, the thickness of the nanoporous hydrophilic layer may be in the range of about 100 nm to about 700 nm. The thickness of the nanoporous hydrophilic layer may be in the range of about 100 nm to about 300 nm. The thickness (nm) of the nanoporous hydrophilic layer may be less than about 700, 600, 500, 400, 300, 250, 240, 230, 220, 200, 150, or 100. The thickness (nm) of the nanoporous hydrophilic layer may be at least about 100, 150, 200, 210, 220, 230, 240, 250, 300, 350, 400, 450, 500, 600, or 700. The thickness of the nanoporous hydrophilic layer may be in a range provided by any two of these upper and/or lower values. The inventors have surprisingly found that the features of the nanofiller and/or thickness of the nanoporous hydrophilic layer formation can provide further advantageous surface properties for association with the hydrophobic substrate. Further advantages can be provided by minimising the thickness of the layer while maintaining effective structural properties, for example, the formation of a nanoporous hydrophilic layer having a thickness of about 230 nm may be provided having an effective and further improved separation performance.

### Hydrophilic Polymer

Hydrophilic polymers contain polar or charged functional groups, rendering them soluble in water. For example, hydrophilic polymers may include, but are not limited to, polyvinyl alcohol (PVA), polyacrylamide, polyurethanes, poly-(hydroxyethyl methacrylamide), poly(ethylene glycol) derivatives, polyacrylonitrile (PAN), polyaniline (PANI), chitosan (CS), cellulose acetate (CA), polybenzimidazole (PBI), polyethersulfone, polysulfone, or combinations thereof. In one particular example, the hydrophilic polymer may be polyvinyl alcohol (PVA).

Polyvinyl alcohol (PVA) is a water soluble hydrophilic polymer and has been studied intensively for membrane applications because of its good chemical stability, film-forming ability and high hydrophilicity. It will be appreciated that high hydrophilicity can be useful for desalination membranes to minimise membrane fouling by natural organic matter. However, PVA has poor stability in water. Modification reactions such as grafting or crosslinking may assist forming a stable membrane with good mechanical properties and selective permeability to water. Previous studies have shown that introducing an inorganic component derived from Si-containing precursors into PVA can form a homogeneous nanocomposite membrane.

In some embodiments or examples, the nanoporous hydrophilic layer may comprise a hydrophilic polymer. For example, the hydrophilic polymer may be polyvinyl alcohol.

In some embodiments or examples, the content of the hydrophilic polymer in the nanoporous hydrophilic layer may be between about 50% and 99% by weight of the nanoporous hydrophilic layer. For example, the content of the hydrophilic polymer in the nanoporous hydrophilic layer may be between about 80% and 99% by weight of the nanoporous hydrophilic layer. The content (wt. %) of the hydrophilic polymer in the nanoporous hydrophilic layer may be less than about 99, 97, 95, 93, 90, 87, 85, 83, 80, 75, 70, 65, 60, 55, or 50. The content (wt. %) of the hydrophilic polymer in the nanoporous hydrophilic layer may be at least about 50, 55, 60, 65, 70, 75, 80, 85, 90, 95, or 99. The content (wt. %) of the hydrophilic polymer in the nanoporous hydrophilic layer may be in a range provided by any two of these upper and/or lower values.

### Crosslinking Agent

In some embodiments or examples, the nanoporous hydrophilic layer may comprise a crosslinking agent. The crosslinking agent may be a chemical crosslinking agent selected from the group comprising sulfosuccinic acid, 4-sulfophthalic acid, 4,6-disulphoisophthalic acid, glutaraldehyde, maleic acid, oxalic acid, fumaric acid, toluene di-isocyanate, citric acid or combinations thereof. In some embodiments or examples, the cross-linking agent may be a sulfonated crosslinking agent. For example, the sulfonated crosslinking agent may be selected from the group comprising sulfosuccinic acid, 4-sulfophthalic acid, or 4,6-disulphoisophthalic acid. For example, the sulfonated crosslinking agent may be selected from sulfosuccinic acid (SSA), maleic acid (MA), or 4-sulfophthalic acid. For example, the sulfonated crosslinking agent may be selected from sulfosuccinic acid (SSA) or 4-sulfophthalic acid. For example, the sulfonated crosslinking agent may be sulfosuccinic acid (SSA). For example, the sulfonated crosslinking agent may be maleic acid (MA).

It has been found that sulfosuccinic acid (SSA), maleic acid (MA), and 4-sulfophthalic acid are advantageous for flux enhancement due to the existence of facilitated transport sites (sulfonic acid groups).

In some embodiments or examples, the content of the crosslinking agent may be between about 1% and 30% by weight of the nanoporous hydrophilic layer. For example, the content of the crosslinking agent may be between about 5% and 20% by weight of the nanoporous hydrophilic layer. The content (wt. %) of the crosslinking agent may be less than about 30, 25, 20, 15, 10, 5, 4, 3, 2, or 1. The content (wt. %) of the crosslinking agent may be at least about 1, 2, 3, 4, 5, 10, 15, 20, 25, or 30. The content (wt. %) of the crosslinking agent based on the total weight of the nanoporous hydrophilic layer may be in a range provided by any two of these upper and/or lower values.

### Nanofiller

The dispersion of nanofillers may provide further advantages to the physicochemical properties of the resultant nanoporous hydrophilic layer including thermal stability, mechanical property, crystallinity, free volume property and thus the subsequent separation performance.

In some embodiments or examples, the nanoporous hydrophilic layer comprises one or more nanofillers. The one or more nanofillers may be selected from the group comprising a MXene, a carbon based nanomaterial, a MOF, and a silica nanoparticle. The nanofiller may be selected from the group comprising a MXene, a carbon based nanomaterials, a MOF, or a silica nanoparticle. The nanofiller may be MXene, carbon-based nanomaterials, or MOFs. The nanofiller may be MXene or carbon-based nanomaterial.

The dispersion of the one or more nanofillers may be uniform. The one or more nanofillers may be two-dimensional or three-dimensional. The nanofiller may be selected from nanosheets, nanoparticles, porous nanoparticles, nanomaterials, or porous nanomaterials. For example, the nanofiller may be two-dimensional nanosheets.

The content of the one or more nanofillers in the nanoporous hydrophilic layer may be in a range between about 0.1% to about 30% by weight of the nanoporous hydrophilic layer. For example, the content of the nanofiller in the nanoporous hydrophilic layer may be in a range between about 0.1% to about 5% by weight of the nanoporous hydrophilic layer. The content (wt. %) of the nanofiller in the nanoporous hydrophilic layer may be less than about 30, 25, 22, 20, 15, 10, 5, 4, 3, 2, 1, 0.5 or 1. The content (wt. %) of the nanofiller in the nanoporous hydrophilic layer may be at least about 0.1, 0.5, 1, 2, 3, 4, 5, 10, 15, 20, 22, 25, or 30. The content (wt. %) of the nanofiller based on the total weight of the nanoporous hydrophilic layer may be in a range provided by any two of these upper and/or lower values.

### MXene

In some embodiments or examples, the nanofiller may be MXene. For example, Ti₃C₂Tₓ MXene.

Two-dimensional (2D) Ti₃C₂Tₓ MXene (e.g. transition metal carbides, nitrides or carbonitrides) nanosheets typically have a five-layered atomic structure built on covalent bonding and uniformly distributed surface functional groups including —OH, —O—, —Cl, and —F. It has been found that these attributes provide MXene with excellent mechanical rigidity, thermostability, chemical functionality as well as good dispersibility in aqueous medium, and as such may be suitable as a nanofiller in polymer-based membranes.

In some embodiments or examples, MXene may comprise the general formula Mₙ₊₁XₙTₓ; M may be selected from the group comprising Ti, Zr, V, Nb, Ta, or Mo; T may be selected from the group comprising O, F, OH or Cl; X may be selected from C or N; and, n and x may be independently selected from 1, 2, 3 or 4.

### Carbon-Based Nanomaterials

In some embodiments or examples, the nanofiller may be selected from a carbon-based nanomaterials. The carbon-based nanomaterials may be selected from the group comprising carbon nanotubes, graphene, graphene oxide, graphitic material, activated carbon, or a combination thereof.

It will be appreciated that carbon nanotubes (CNT) may consist of graphene sheets rolled up in a tubular fashion, and according to the synthetic method, single wall carbon nanotubes (SWCNT) or multiwalled carbon nanotubes (MWCNT) can be obtained. CNT are known for their exceptional mechanical and electric properties as well as their high chemical and thermal stability.

Graphitic materials may consist of primarily carbon and may exist in forms such as graphite, carbon nanotubes, graphene, and activated carbon. It will be appreciated that the graphitic structure of graphitic materials may be enhanced by substituting a carbon atom for another element such as nitrogen, boron, phosphorus, and sulphur, for example.

### Metal-Organic Frameworks (MOFs)

In some embodiments or examples, the nanofiller may be selected from a MOF. The MOF may be selected from water stable MOFs and MOF-based composites. It will be appreciated that water stable MOFs and MOF-based composites may be any MOF that is stable in an aqueous environment. The MOF may comprise metal ions or metal clusters each coordinated to one or more organic ligands to form a one-, two- or three dimensional network. The MOF may be selected to have a porous three dimensional network. Any suitable MOF can be used as a nanofiller of the present disclosure. With over 50,000 different MOFs available, there are a wide range of MOFs that can be selected based on compliant or complementary chemistry, pore size, surface area, void fraction, open metal sites, ligand functionality and many other characteristics. It will be appreciated that MOFs (also known as coordination polymers) are a class of hybrid crystal materials where metal ions or small inorganic nanoclusters are linked into one-, two- or three- dimensional networks by multi-functional organic linkers. In this sense, MOF is a coordination network with organic ligands containing potential voids.

Water stable MOFs may be classified as those that do not exhibit structural breakdown under exposure to water content. Stability of MOFs in water is highly related to the strength of coordination bonds. Water stable MOFs may be categorised into three major types: (1) metal carboxylate frameworks consisting of high-valence metal ions; (2) metal azolate frameworks containing nitrogen-donor ligands; (3) MOFs functionalized by hydrophobic pore surfaces or with blocked metal ions. For example, the water stable MOF and MOF-based composites may be selected from the group comprising MIL series (e.g. MIL-53, MIL-100 and MIL-101), UiO series (e.g. UiO-66, UiO-67, and UiO-68), zeolitic imidazolate frameworks (ZIFs), triazole and pyrazolate-based MOFs (e.g. MAF series), Al based MOFs (AlFu, aluminium succinate), or combinations thereof.

### Hydrophobic Support Material

The membrane as described herein may comprise a nanoporous hydrophilic layer supported on a porous hydrophobic substrate.

It has surprisingly been found that a porous hydrophobic support substrate can provide excellent chemical and thermal stability, hydrophobicity, high porosity, and an ultralow coefficient of friction ideal for fast transport of permeates during separation process.

In some embodiments or examples, the porous hydrophobic substrate may comprise a polymeric material selected from the group comprising polytetrafluoroethylene (PTFE), polypropylene (PP), polyvinylidene fluoride (PVDF), poly-(vinylidene difluoride-hexafluoropropylene copolymer) (PVDF-co-HFP), polypropylene (PP) supported polytetrafluoroethylene (PTFE), or acrylic copolymer. For example, the porous hydrophobic substrate may be polytetrafluoroethylene (PTFE) or a polypropylene (PP) supported polytetrafluoroethylene (PTFE).

In some embodiments or examples, the porous hydrophobic substrate may comprise a hydrophobic composite layer. The porous hydrophobic support substrate may comprise two or more hydrophobic composite layers. The composite layer may comprise one or more hydrophobic polymeric materials within a polymeric matrix, wherein the hydrophobic polymeric materials may be dispersed fibres within the polymeric matrix. The polymeric material may be dispersed, woven, interlaced, or laminated, on or within the porous hydrophobic substrate. The polymeric material may be provided in the form of one or more fibres. The content of the fibres may comprise a polymeric material selected from the group comprising polytetrafluoroethylene (PTFE), polypropylene (PP), polyvinylidene fluoride (PVDF), poly-(tetrafluoraoethylene-hexafluoropropylene copolymer) (FEP), poly(ethylene tetrafluoroethylene) (ETFE), polychlorotrifluoroethylene (PCTFE), poly-(tetrafluoroethylene-perfluoropropylvinyl ether copolymer) (PFA), poly-(vinylidene difluoride-hexafluoropropylene copolymer) (PVDF-co-HFP) or acrylic copolymer.

For example, the porous hydrophobic substrate may be polytetrafluoroethylene (PTFE) or a polypropylene (PP) supported polytetrafluoroethylene (PTFE). The porous hydrophobic substrate may be polytetrafluoroethylene (PTFE). The porous hydrophobic substrate may be polypropylene (PP) supported polytetrafluoroethylene (PTFE)

In some embodiments or examples, the porous hydrophobic substrate is microporous.

In some embodiments or examples, porous hydrophobic substrate may have a pore size distribution in the range of from about 0.1 μm to about 5 μm. In some embodiments or examples, porous hydrophobic substrate may have a pore size distribution in the range of from about 0.2 μm to about 1 μm. The pore size distribution (μm) may be less than about 5, 4, 3, 2, 1, 0.8, 0.6, 0.4, 0.2 or 0.1. The pore size distribution (μm) may be at least about 0.1, 0.2, 0.4, 0.6, 0.8, 1, 2, 3, 4, or 5. The pore size distribution of the porous hydrophobic substrate may be in a range provided by any two of these upper and/or lower values.

### Preparation Process

In some embodiments or examples, the present disclosure is directed to a process for preparing a membrane comprising a nanoporous hydrophilic layer supported on a porous hydrophobic substrate. In some embodiments or examples, the present disclosure is directed to a process for preparing a pervaporation membrane suitable for use in membrane distillation and/or pervaporation including desalination and/or solvent dehydration membrane The process may be for preparing a membrane according to any embodiments or examples as described herein.

It will be appreciated that the membrane prepared by the process may comprise a nanoporous hydrophilic layer supported on a porous hydrophobic substrate. The membrane prepared by the process may consist of a nanoporous hydrophilic layer supported on a porous hydrophobic substrate, wherein the hydrophilic layer may consist of a hydrophilic polymer, optionally one or more crosslinkers, and optionally one or more nanofillers. In some embodiments or examples, the nanoporous hydrophilic layer prepared by the process may comprise or consist of a water soluble polymer, a crosslinking agent, and optionally one or more nanofillers. In some embodiments or examples, the hydrophilic layer prepared by the process may comprise or consist of a water soluble polymer, a sulphonated crosslinking agent, and optionally one or more nanofillers. In some embodiments or examples, the hydrophilic layer prepared by the process may comprise or consist of a water soluble polymer, a sulphonated crosslinking agent, and a nanofiller. For example, the hydrophilic layer prepared by the process may comprise or consist of a polyvinyl alcohol, a sulphonated crosslinking agent, and a nanofiller. For example, the hydrophilic layer prepared by the process may comprise or consist of a polyvinyl alcohol, a sulphonated crosslinking agent, and a MXene. In another example, the hydrophilic layer prepared by the process may comprise or consist of a polyvinyl alcohol, a sulphonated crosslinking agent, and a carbon-based nanoparticle.

The hydrophilic polymer, crosslinking agent, nanofiller, hydrophobic substrate, and solvent system may be selected from any one or more of the embodiments or examples as described herein.

In some embodiments or examples, a process for preparing a membrane may comprise a nanoporous hydrophilic layer supported on a porous hydrophobic substrate, the process may comprise the steps of: (i) preparing a hydrophilic casting solution comprising a hydrophilic polymer, optionally a crosslinking agent, optionally a nanofiller, and a solvent system; (ii) casting a layer of the hydrophilic casting solution onto a porous hydrophobic substrate to provide a wet hydrophilic layer supported on the porous hydrophobic substrate.

In some embodiments or examples, the process may further comprise step (iii) solidifying the wet hydrophilic layer by (a) solvent evaporation and/or (b) heat treatment to provide a dry hydrophilic layer supported on the porous hydrophobic substrate.

In some embodiments or examples, the content of crosslinking agent in the hydrophilic casting solution may be in a range of about 1% and 30% by weight of the total content of the hydrophilic polymer. For example, the content of the crosslinking agent may be between about 5% and 20% by weight of the nanoporous hydrophilic layer. The content (wt. %) of the crosslinking agent may be less than about 30, 25, 20, 15, 10, or 5. The content (wt. %) of the crosslinking agent may be at least about 5, 10, 15, 20, 25, or 30. The content (wt. %) of the crosslinking agent based on the total weight of the nanoporous hydrophilic layer may be in a range provided by any two of these upper and/or lower values.

In some embodiments or examples, the concentration of nanofiller in the hydrophilic casting solution may be in a range of about 0.1% and 30% by weight of the total content of the hydrophilic polymer. For example, the content of the nanofiller in the nanoporous hydrophilic layer may be between about 0.1% to about 5% by weight of the nanoporous hydrophilic layer. The content (wt. %) of the nanofiller in the nanoporous hydrophilic layer may be less than about 30, 25, 20, 15, 10, 5, 4, 3, 2, 1, 0.5 or 1. The content (wt. %) of the nanofiller in the nanoporous hydrophilic layer may be at least about 0.1, 0.5, 1, 2, 3, 4, 5, 10, 15, 20, 25, or 30. The content (wt. %) of the nanofiller based on the total weight of the nanoporous hydrophilic layer may be in a range provided by any two of these upper and/or lower values.

In some embodiments or examples, the viscosity of the hydrophilic casting solution may be between about 10 mPas and 2000 mPas. The viscosity (mPas) may be less than about 2000, 1000, 800, 600, 400, 200, 100, 50, or 10. The viscosity may be at least about 10, 20, 40, 60, 80, 100, 300, 500, 700, 900, 1000, or 2000. The viscosity (mPas) of the casting solution may be in a range provided by any two of these upper and/or lower values.

In some embodiments or examples, the thickness of the wet hydrophilic layer may be in a range between about 4 and 100 μm. The thickness (μm) may be less than about 100, 80, 60, 40, 20, 15, 10, 8, 6, or 4. The thickness (μm) may be at least about 4, 6, 8, 10, 15, 20, 30, 40, 50, 60, 70, 80, 90 or 100. The thickness (μm) of the wet hydrophilic layer may be in a range provided by any two of these upper and/or lower values. For example, the thickness of the wet hydrophilic layer may be about 50 μm.

In some embodiments or examples, the thickness of the dry hydrophilic layer may be in a range between about 100 and 700 nm. The thickness of the dry hydrophilic layer may be in the range of about 100 nm to about 300 nm. The thickness (nm) of the dry hydrophilic layer may be less than about 700, 600, 500, 400, 300, 250, 240, 230, 220, 200, 150, or 100. The thickness (nm) of the dry hydrophilic layer may be at least about 100, 150, 200, 210, 220, 230, 240, 250, 300, 350, 400, 450, 500, 600, or 700. The thickness of the dry hydrophilic layer may be in a range provided by any two of these upper and/or lower values.

In some embodiments or examples, the solvent system may be water. In some embodiments or examples, the concentration of hydrophilic polymer in water for step (i) may be in a range between 0.1 and 20 wt. % based on the total volume hydrophilic casting solution. For example, the concentration of hydrophilic polymer in water for step (i) may be in a range between 0.5 and 10 wt. % based on the total volume hydrophilic casting solution. The concentration (wt. %) of hydrophilic polymer may be less than about 20, 18, 16, 14, 12, 10, 8, 6, 4, 2, 1, 0.5, 0.1. The concentration (wt. %) of hydrophilic polymer may be at least about 0.1, 0.5, 1, 2, 4, 6, 8, 10, 12, 14, 16, 18, or 20. The concentration (wt. %) of hydrophilic polymer based on the total volume of the hydrophilic casting solution may be in a range provided by any two of these upper and/or lower values.

In some embodiments or examples, the wet hydrophilic layer may be maintained at a temperature of between about 70° C. and about 160° C. in step (iii)(a) for about 30 minutes to about 48 hours. The wet hydrophilic layer may be maintained at a temperature (° C.) of less than about 160, 140, 120, 100, 90, 80, or 70. The wet hydrophilic layer may be maintained at a temperature (° C.) of at least about 70, 80, 90, 100, 120, 140, or 160. The wet hydrophilic layer may be maintained at a temperature (° C.) in a range provided by any two of these upper and/or lower values. The wet hydrophilic layer may be maintained at a temperature as described herein for less than about 48 hours, 30 hours, 20 hours, 10 hours, 5 hours, 1 hour, or 30 minutes. The wet hydrophilic layer may be maintained at a temperature as described herein for at least about 30 minutes, 1 hour, 5 hours, 10 hours, 20 hours, 30 hours, or 48 hours. The wet hydrophilic layer may be maintained at a temperature as described herein for a time in a range provided by any two of these upper and/or lower values.

Upon formation of the casting solution, some or all of the solvent may be removed (e.g., by natural evaporation or under vacuum) to generate a solid or viscous casting solution. The casting solution may be formed or moulded in any desired shape, such as membrane having a predetermined thickness.

In some embodiments or examples, the casting solution may be deposited on a porous hydrophobic substrate to generate a supported nanoporous hydrophilic layer. It will be appreciated that a supported nanoporous hydrophilic layer may be the combination of the porous hydrophobic substrate and the nanoporous hydrophilic layer, also referred to as a nanoporous hydrophilic layer supported on a porous hydrophobic substrate or a dual-layer membrane. Porous hydrophobic substrates of varying pore size may be used within the present disclosure, generating supported dual-layer membranes of distinct porosity. In some embodiments or examples, the nanoporous hydrophilic layer may be localized on the surface of the porous hydrophobic substrate and may not penetrate the porous hydrophobic substrate.

During preparation of a dual-layer membrane, the nanoporous hydrophilic layer may be applied to only a portion of the surface of the porous hydrophobic substrate. In some embodiments or examples, the portion (%) may be less than about 100, 95, 90, 85, 80, 75, 70, 65, 60, 55, 50, 45, 40, 35, 30, 25, 20, 15, 10, or 5. In some embodiments or examples, the nanoporous hydrophilic layer may be applied by solvent casting on the porous hydrophobic substrate. In other embodiments or examples, the nanoporous hydrophilic layer may be applied a multitude of times to the porous hydrophobic substrate, in order to obtain the desired nanoporous hydrophilic layer thickness. In some embodiments or examples, the nanoporous hydrophilic layer may be in the form of a single layer attached to the porous hydrophobic substrate. In another embodiment, the nanoporous hydrophilic layer may be in the form of two or more layers, such as stacked sheets attached to the porous hydrophobic substrate. The nanoporous hydrophilic layer may comprise between about 1 to 50 layers. The nanoporous hydrophilic layer may comprise less than 50 layers, 40 layers, 30 layers, 20 layers, 10 layers, 8 layers, 6 layers, 4 layers, or less than 2 layers. The nanoporous hydrophilic layer may comprise at least about 1 layer, at least about 2 layers, at least about 3 layers, at least about 4 layers, at least about 5 layers, at least about 6 layers, at least about 7 layers, at least about 8 layers, at least about 9 layers, at least about 10 layers, at least about 20 layers, at least about 30 layers, at least about 40 layers, or at least about 50 layers. The nanoporous hydrophilic layer may comprise layers in a range provided by any lower and/or upper limit as previously described.

In some embodiments or examples, the nanoporous hydrophilic layer may be attached to the porous hydrophobic substrate. In other embodiments or examples, the nanoporous hydrophilic layer may form a layer on the surface of the porous hydrophobic substrate. In some embodiments or examples, the thickness of the nanoporous hydrophilic layer may be in a range between about 100 and 700 nm. The thickness of the nanoporous hydrophilic layer may be in the range of about 100 nm to about 300 nm. The thickness (nm) of the nanoporous hydrophilic layer may be less than about 700, 600, 500, 400, 300, 250, 240, 230, 220, 200, 150, or 100. The thickness (nm) of the nanoporous hydrophilic layer may be at least about 100, 150, 200, 210, 220, 230, 240, 250, 300, 350, 400, 450, 500, 600, or 700. The thickness of the nanoporous hydrophilic layer may be in a range provided by any two of these upper and/or lower values.

### Pervaporation and Membrane Distillation

In some embodiments or examples, the present disclosure also provides a method for the separation of water from a mixture. The present disclosure may also provide a method for the separation of two or more aqueous solutions. The method may comprise the use of a membrane comprising a nanoporous hydrophilic layer supported on a porous hydrophobic substrate, at least according to any one of the embodiments or examples as described herein, for separating water from aqueous-ion mixtures. The method may also comprise the use of a membrane comprising a nanoporous hydrophilic layer supported on a porous hydrophobic substrate, at least according to any one of the embodiments or examples as described herein, for separating water from alcohol mixtures. The method may also comprise the use of a membrane comprising a nanoporous hydrophilic layer supported on a porous hydrophobic substrate, at least according to any one of the embodiments or examples as described herein, for separating two or more aqueous solutions. The method may also comprise the use of a membrane comprising a nanoporous hydrophilic layer supported on a porous hydrophobic substrate, at least according to any one of the embodiments or examples as described herein, in combination with reverse osmosis treatment.

The present disclosure advantageously provides a membrane comprising a nanoporous hydrophilic layer supported on a porous hydrophobic substrate, at least according to any one of the embodiments or examples as described herein, which can be particularly effective for use in separation, such as solvent dehydration, organic/organic separation, and pervaporation desalination. The membranes according to at least some embodiments of examples as described herein can be capable of maintaining a stable throughput without any substantial attenuation in molecule separation throughout long-term operation (50 hours), providing a mechanically robust and structurally stable separating nanoporous hydrophilic layer under continuous operation.

### Solvent Dehydration

It has been found that the membrane comprising a nanoporous hydrophilic layer supported on a porous hydrophobic substrate, at least according to any one of the embodiments or examples as described herein, provides a particularly effective membrane for use in solvent dehydration capable of maintaining a stable throughput without attenuation in molecule separation throughout long-term operation (50 hours), providing a mechanically robust and structurally stable separating nanoporous hydrophilic layer under continuous operation. In some embodiments or examples, the membrane comprising a nanoporous hydrophilic layer supported on a porous hydrophobic substrate, at least according to any one of the embodiments or examples described herein, may have a water permeation flux of at least about 1.0 kg m⁻² h⁻¹ with water in the permeate stream of at least 97 wt. %. In some embodiments or examples, the water permeation flux (kg m⁻² h⁻¹) of at least about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0. In some embodiments or examples, the water permeation flux (kg m⁻² h⁻¹) of less than about 3.0, 2.8, 2.6, 2.4, 2.2, 2.0, 1.8, 1.6, 1.4, 1.2, or 1.0. The water permeation flux (kg m⁻² h⁻¹) may be in a range provided by any two of these upper and/or lower values. In some embodiments or examples, the water in the permeate stream (wt. %) may be at least about 97, 97.5, 98, 98.5, 99, 99.5, 99.7, or 99.9. In some embodiments or examples, the water in the permeate stream (wt. %) may be less than about 99.9, 99.7, 99.5, 99.2, 99, 98.5, 98, 97.5, or 97. The water in the permeate stream (wt. %) may be in a range provided by any two of these upper and/or lower values.

In some embodiments or examples, the membrane comprising a nanoporous hydrophilic layer supported on a porous hydrophobic substrate, at least according to any one of the embodiments or examples described herein, may have a water permeation flux of at least about 1.0 kg m⁻² h⁻¹ with a separation factor of at least 950. In some embodiments or examples, the water permeation flux (kg m⁻² h⁻¹) of at least about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9 or 3.0. In some embodiments or examples, the water permeation flux (kg m⁻² h⁻¹) of less than about 3.0, 2.8, 2.6, 2.4, 2.2, 2.0, 1.8, 1.6, 1.4, 1.2, or 1.0. The water permeation flux (kg m⁻² h⁻¹) may be in a range provided by any two of these upper and/or lower values. In some embodiments or examples, the separation factor may be at least about 950, 1000, 2000, 3000, 4000, 5000, 6000, 7000, 8000, 9000, 10,000, 15,000, 20,000, or 25,000. In some embodiments or examples, the separation factor may be less than about 25,000, 20,000, 15,000, 10,000, 9000, 8000, 7000, 6000, 5000, 4000, 3000, 2000, or 1000. The separation factor may be in a range provided by any two of these upper and/or lower values.

In some embodiments or examples, the solvent may be non-polar, polar aprotic, and/or polar protic. In some embodiments or examples, the solvent may be any one or more of aliphatic and aromatic hydrocarbons, chlorinated aromatic and aliphatic hydrocarbons, ethers, ketones, amides, nitriles, and alcohols. For example, the solvent may be a water/alcohol mixture, wherein the alcohol may be methanol, ethanol, propanol, or butanol.

### Desalination

It has been found that the membrane comprising a nanoporous hydrophilic layer supported on a porous hydrophobic substrate, at least according to any one of the embodiments or examples described herein, provides a particularly effective membrane for use in pervaporation desalination capable of maintaining a stable throughput without attenuation in molecule separation throughout long-term operation (50 hours), providing a mechanically robust and structurally stable separating nanoporous hydrophilic layer under continuous operation. In some embodiments or examples, the membrane comprising a nanoporous hydrophilic layer supported on a porous hydrophobic substrate, at least according to any one of the embodiments or examples described herein, in pervaporation desalination may have a water permeation flux of at least about 15 kg m⁻² h⁻¹ with salt rejection of at least about 99.2%. In some embodiments or examples, the water permeation flux (kg m⁻² h⁻¹) may be at least about 15, 20, 25, 30, 35, 40, 45, 50, 55, 60, 65, 70, 75, or 80. In some embodiments or examples, the water permeation flux (kg m⁻² h⁻¹) may be less than about 80, 75, 70, 65, 60, 55, 50, 45, 40, 35, 30, 25, 20, or 15. The water permeation flux (kg m⁻² h⁻¹) may be in a range provided by any two of these upper and/or lower values. In some embodiments or examples, the salt rejection (%) may be at least about 99.2, 99.3, 99.4, 99.5, 99.6, 99.7, 99.8, or 99.9. In some embodiments or examples, the salt rejection may be less than about 99.9, 99.8, 99.7, 99.6, 99.5, 99.4, 99.3, or 99.2. The salt rejection (%) may be in a range provided by any two of these upper and/or lower values. For example, the water permeation flux may be at least about 45 kg m⁻² h⁻¹ and the water rejection at least about 99.8%.

### Pervaporation and Membrane Distillation Method

The present disclosure further provides a method of separating a component from a first fluid mixture. The method comprises the step of bringing the first fluid mixture into contact with the inlet side of a dual layer membrane as described herein. The method further comprises the step of applying a driving force across the dual-layer membrane. The method further comprises the step of withdrawing from the outlet side of the dual-layer membrane a second fluid mixture, wherein the proportion of the component in the second fluid mixture is depleted or enriched as compared with the first fluid mixture.

The method as described herein can also be described as a process for separating a component from a fluid mixture that contains the component, the process comprising contacting the fluid mixture with the dual-layer membrane as described herein; providing a driving force, for example a difference in pressure, across the dual-layer membrane to facilitate transport of the component through the dual-layer membrane such that a separated fluid mixture is provided, wherein the concentration of the component in the separated fluid mixture may be higher than the concentration of the component in the fluid mixture that was subjected to separation.

In some embodiments or examples, the fluid mixture may be a liquid or gaseous mixture. In some embodiments or examples, the component may be an organic solvent, ion, gas, impurity or contaminant. In some embodiments or examples, the proportion of the component in the second fluid mixture or in the separated fluid mixture may be depleted or enriched as compared with the first fluid mixture by about 10,000%, about 8,000%, about 6,000%, about 4,000%, about 2,000%, about 1,000%, about 900%, about 800%, about 700%, about 600%, about 500%, about 400%, about 300%, about 200%, about 100%, about 80%, about 60%, about 40%, about 20%, about 10%, or about 5%.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLES

The present disclosure is further described by the following examples. It is to be understood that the following description is for the purpose of describing particular examples only and is not intended to be limiting with respect to the above description.

### Example 1 General Process for the Preparation of a Nanoporous Hydrophilic Layer

A dope solution was prepared by dissolving a hydrophilic polymer PVA (0.5-10 wt %) in DI water at 90° C. followed by dropwise addition of a solution comprising a crosslinking agent (5-20 wt %) and a nanofiller (0.1-10 wt %) dispersed in DI water. In an example, the composition of the dope solution could be varied by changing the nanofiller content (1, 2, 3, 4, 5 or 10 wt %) relative to the hydrophilic polymer while the crosslinking agent was fixed at about 20 wt %. The dope solution underwent ultrasonication and then degassing process before casting process was carried out automatically by RK multicoater (RK PrintCoat Instruments Ltd) to form a thin nanoporous hydrophilic layer.

### Example 1a Preparation of a PVA/SSA/CNT Nanoporous Hydrophilic Layer

The pristine CNTs (Multi-walled carbon nanotubes or functionalized multi-walled carbon nanotubes) can be used as the nanofiller with or without acid treatment. For acid treatment, 0.5 g of pristine CNTs were placed in a 250 mL round-bottom flask containing 100 ml of the acid mixture (H₂SO₄:HNO₃=3:1 in volumetric ratio). After sonication for 5 min, the round-bottom flask with reflux set up was fixed in silicone oil bath with heating at constant temperature at 60° C. as well as magnetic stirring (450 rpm). The reaction was conducted for 2, 4 and 6 h to impart different degrees of oxidation. When the acid-treatment was finished, the solution was cooled to ambient temperature followed by dilution using 2 L of deionized water. Then the diluted solution was repeatedly dialyzed using a CelluSep H1 dialysis tube with a MWCO of 2000 Da. The resulting acid-treated CNT dispersion separated using a centrifuge and precipitate was dried at 30° C. in vacuum oven before characterization and addition into the polymer. The modified CNTs were labelled as ACNT2, ACNT4 or ACNT6, in which the number indicated the acid-treatment time.

A uniform PVA solution (3 wt %) was obtained by heating at 95° C. with steady stirring. Then either pristine or acid-treated CNTs derived from different reaction time were added into the PVA solution. The concentration of CNTs was 5 wt % relative to PVA. Afterwards, SSA was also added in the PVA/CNT mixture. The concentration of SSA with respect to PVA was about 20 wt. %. The pH of the aqueous solution was adjusted to 1.8±0.2 by HCl (as the crosslinking catalyst) drop-wisely if necessary. The PVA/SSA/CNT mixture was stirred for 10 min followed by further ultrasonication for 30 min.

### Example 1b Preparation of a PVA/SSA/MXene Nanoporous Hydrophilic Layer

The dope solution was prepared by dissolving PVA powder in DI water at 90° C. followed by addition of MXene nanosheets and SSA crosslinking agent. The composition of the PVA/SSA/MXene mixture could be varied by changing the MXene content (1, 2 and 3 wt %) relative to PVA while SSA was fixed at 20 wt %. The PVA/SSA/MXene mixture underwent ultrasonication and then degassing process before casting process was carried out using an automatic RK multicoater (RK PrintCoat Instruments Ltd).

### Example 1c Preparation of a PVA/SSA/AlFu-MOF Nanoporous Hydrophilic Layer

PVA solution was prepared by adding 3 g PVA powder into 97 ml of deionized water at room temperature under vigorous stirring for 1 hour, and then the mixture was transferred and heated in a silicone oil bath at 95° C. under continuous stirring until fully dissolved. The obtained ˜3 wt % PVA solution was allowed to cool to room temperature and then filtered using paper towel. The crosslinking agent 0.857 g of SSA (70 wt % in water, the weight content of SSA with respect to the mass of PVA was 20%) was then added into the PVA solution and stirred for 30 minutes. As for the nanofiller, 0.2 g of AlFu MOF was dispersed in 9.8 g of deionized water and sonicated in an ice bath for 1 hour using Digital Pro+ ultrasonicator to obtain 2 wt % AlFu MOF-water mixture. Then, the predetermined AlFu MOF-water mixture was added dropwise to the PVA-SSA solution and stirred for 30 min at room temperature followed by sonication in an ice bath for another 30 min to achieve homogeneous dope solution with different concentration of nanofiller (1%, 5% or 10%). All the dope solutions were degassed for 2 hours using a vacuum oven at room temperature.

### Example 2 General Process for the Formation of a Dual-Layer Membrane Comprising a Nanoporous Hydrophilic Layer on a Microporous Hydrophobic Substrate

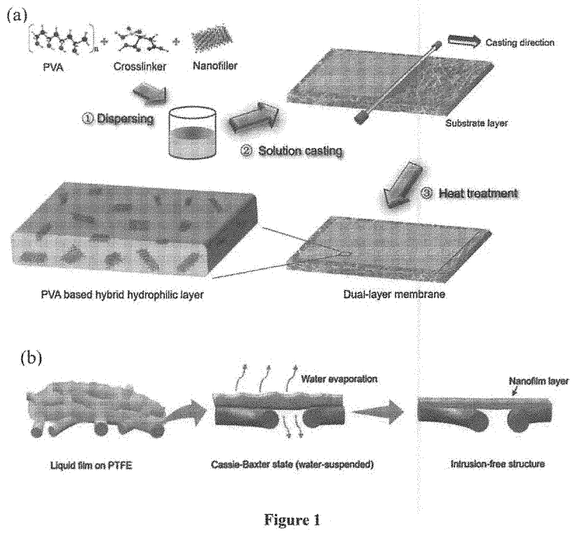

FIG. 1a shows a schematic diagram of the fabrication process for nanoporous hydrophilic layer on the hydrophobic substrate by a controlled shear-induced casting process. As illustrated in FIG. 1b, the hydrophilic casting solution maintained such suspended state whereas water could evaporate via both sides of the liquid layer. A homogeneous doped solution as prepared in Example 1 was first obtained after stirring and subsequent ultrasonication (Step 1). Solution casting was conducted with the assistance of a coating rod with the controlled wet film thickness attached on the RK multicoater (Step 2) to provide a wet hydrophilic layer supported on a porous hydrophobic substrate. During the subsequent stage, the formation of thin layer was realized by evaporation of solvent (water) out from the as-casted liquid layer to provide a dry hydrophilic layer supported on the porous hydrophobic substrate. The obtained dual-layer membrane was further subjected to heat treatment at 85° C. (30-60 min depending on the dual-layer membrane thickness) (Step 3), which could lead to covalent linkages between hydrophilic polymer chains.

### Example 2a Formation of a Dual-Layer Membrane Comprising a PVA/SSA/CNT Nanoporous Hydrophilic Layer on a PTFE Hydrophobic Substrate

The PVA/SSA/CNT casting solution prepared in Example 1a was stirred for 10 minutes followed by further ultrasonication for 30 min. After degassing for 12 h, solution casting was carried out on the PP supported PTFE hydrophobic substrate. The wet hydrophilic layer was left until fully dried (dry hydrophilic layer) and then subject to heat treatment at 100° C. for 30 min. The obtained dual-layer membranes are herein referred to as PSC/PTFE, PSA2/PTFE, PSA4/PTFE and PSA6/PTFE where PSC was short for PVA/SSA/pristine CNT and PSA2 represented PVA/SSA/ACNT2 for instance. Composite membranes without CNTs, such as PVA/SSA (PS/PTFE) and PVA/MA (PM/PFTE) were also fabricated as control samples. For investigation of water transport property and material characterizations, thick free-standing hydrophilic layers (15 μm thick) were prepared following the same procedure as mentioned above except that the PVA based mixture was cast on a plastic plate and peeled off before heating.

### Example 2b Formation of a Dual-Layer Membrane Comprising a PVA/SSA/MXene Nanoporous Hydrophilic Layer on a PTFE Hydrophobic Substrate

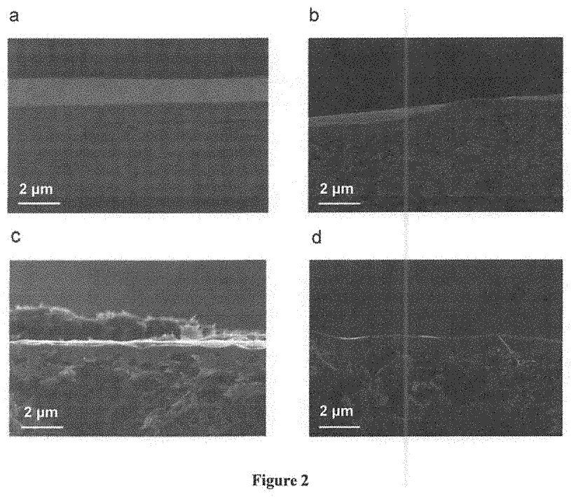

A homogeneous PVA/SSA/MXene (PSM) doped solution was first obtained after proper stirring and subsequent ultrasonication. Solution casting was therewith conducted with the assistance of a coating rod. During the subsequent stage, the formation of thin PVA based layer was realized by evaporation of solvent (water) out from the as-casted liquid layer. The obtained dual-layer membrane was further subjected to heat treatment at 85° C. (60 min). As the water content decreased, the concentration of solid substance increased inversely, resulting in narrowing of the intermolecular distance and solidifying the PVA chains to form a continuous polymer matrix with dispersed MXene nanosheets and SSA, and thus the subsequent nanoporous hydrophilic layer on top of the porous hydrophobic substrate without pore intrusion. To further confirm this, a series of hydrophilic substrates including cellulose acetate (CA), PES and nylon with various pore sizes were also used as the substrate layer using this casting method (FIG. 2). The bottom of the thin hydrophilic layer showed unevenly intruded geometry with those hydrophilic support substrates whereas a clear boundary between the hydrophilic layer and porous hydrophobic support substrate was present for the porous hydrophobic PTFE supported substrate, evidencing the intrusion-free formation of PVA based layer via the abovementioned suspended state.

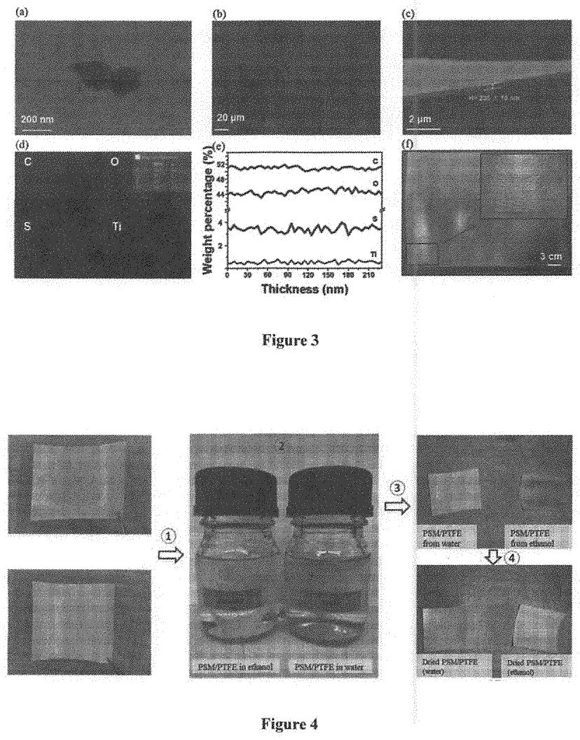

For nanoporous hydrophilic layers, the dimensions of inorganic nanofillers are to be less than the fabricated nanoporous hydrophilic layer thickness so as to obtain large nanofiller-polymer interfacial area while avoiding nonselective defects. TEM confirmed the size of the nanofiller, for example Ti₃C₂Tₓ MXene nanosheets, as observed in FIG. 3a. For the fabricated dual-layer membrane (e.g. PSM/PTFE) having approx. 230 nm thick nanoporous hydrophilic layer), the top-view morphology is presented in FIG. 3b by FESEM that exhibited a dense, continuous and defect-free coverage on the underlying porous hydrophobic support substrate. The corresponding EDS mapping of the membrane surface (FIG. 3d) revealed its homogeneous elemental distributions containing C (51.7 wt %), O (44.2 wt %), S (3.6 wt %) and Tᵢ (0.5 wt %). That demonstrated the dual-layer membrane (e.g. PSM/PTFE) had uniform dispersion of both SSA and MXene simultaneously on the surface. Meanwhile, the ultrathin nanoporous hydrophilic layer (e.g. PSM layer with thickness of ≈230 nm that was realized by controlled solution casting process) can be observed in the cross-section image (FIG. 3c). EDS line scan results (FIG. 3e) provided consistent elemental distributions with those on the surface of the nanoporous hydrophilic layer, further affirming the successful incorporation and even dispersion state of SSA and MXene in the PVA matrix. In addition, FIG. 3f presents a photograph of large-area membrane (30×30 cm²) composed of semitransparent green thin nanoporous hydrophilic layer intimately laminated on the PTFE porous hydrophobic substrate with a magnified section showing its ultrathin morphology. Such dual-layer membrane (e.g. PSM/PTFE) configurations also withstood long-term immersion (500 h) in both water and ethanol without any sign of delamination (FIG. 4), exhibiting excellent interfacial adhesion and stability. The test involved two pieces of PSM/PTFE membranes were chosen and immersed in water and ethanol, respectively (Step 1). The immersed membranes were kept in the water- or ethanol-filled glassware for 500 hours (Step 2). The membrane samples were removed from the solvent (Step 3). As can be seen, there was liquid on the surface of PSM/PTFE of the water-wetted sample while for the ethanol-wetted one, the PTFE substrate turned transparent. The samples were left to dry (Step 4) in the ambient environment for 24 hours and the PVA based thin nanoporous hydrophilic layer can be found to remain on top of the porous PTFE hydrophobic substrate as it was before the immersion.

The synthesized dual-layer membranes were denoted as PSM/PTFE, PVA/PTFE and PS/PTFE (PVA with 20 wt % SSA and 2 wt % MXene, neat PVA and PVA with 20 wt % SSA on the PP supported PTFE substrates, respectively).

### Example 2c Formation of a Dual-Layer Membrane Comprising a PVA/SSA/AlFu-MOF Nanoporous Hydrophilic Layer on a PTFE Hydrophobic Substrate

The dual-layer membranes were fabricated using the solution casting method, followed by drying and heat treatment, as mentioned above in Examples 2a and 2b.

10 mL of dope solution was casted on the flat-sheet PTFE membrane using the RK K303 multicoater (RK PrintCoat Instruments Ltd.) at a constant speed with the wet film thickness being controlled at 8 μm. The obtained membrane samples were dried at room temperature and the casting procedure could be repeated. Then, the membranes were heat-treated at 80° C. in a convection oven for 1 h. The dual-layer membranes (optimized at 2 solution casting repeats) containing PVA-SSA, PVA-SSA-AlFu-MOF 1%, 5%, 10% were denoted as PS, PSA-1, PSA-5 and PSA-10, respectively.

### Example 3 Pervaporation Performance Testing

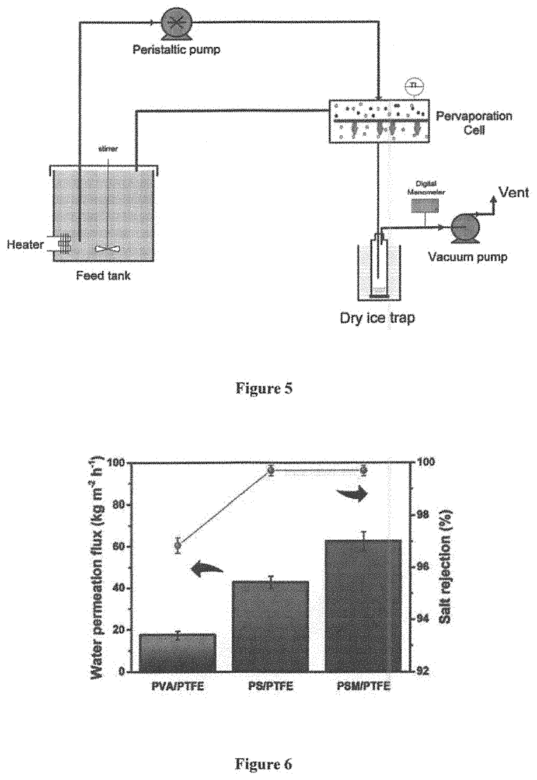

PV separation tests were examined by evaluating the retention of salts or alcohol using a bench-scale stainless PV unit (FIG. 5). The effective transporting area of the composite membrane is 9.6 cm². 0.6 M synthetic NaCl solution or other saline solutions such as KCl, Na₂SO₄, MgCl₂, CaCl₂ and MgSO₄ was used as the feed solution to evaluate the desalination performance of the PVA based dual-layer membrane and 96 wt % C1 to C4 (methanol, ethanol, iso-propanol and tert-butanol) alcohol-water mixture was employed to obtain the alcohol dehydration performance. The salt solution or alcohol/water mixture was in cyclic flow on the upstream side of the membrane with a velocity of 50 mL min⁻¹ enabled by a peristaltic pump (Masterflex). The feed temperature was maintained as required (30, 50 or 70° C.) via a water bath. The temperature in the feed chamber was monitored by a thermocouple (K-type). 130 Pa of vacuum pressure was applied and kept on the permeate side by a vacuum pump for all the performance tests. The permeates were condensed in a dry-ice (desalination) or liquid nitrogen (alcohol dehydration) cold trap. The performance test was conducted for 3 h after reaching a stable state whereas the long-term stability test lasted for 50 h. Salt rejection (R), separation factor (a) for dehydration of ethanol and water permeation flux (Jᵢ) were employed to evaluate the separation properties of the membranes.

For PV desalination, a pre-calibrated conductivity meter (Oakton® Con 110) was used to obtain the salt concentrations of the feed (C_{f}) and permeate (Cₚ). For PV dehydration of alcohol, the weight percentages of component in the feed and permeate (i and j) were referred to as X and Y, respectively. Jᵢ (kg m⁻² h⁻¹) represented the permeation flux derived from the mass (Mᵢ) of permeate collected from the cold trap, the effective membrane separating area (A) and the operation time (t). The alcohol in the permeate side was determined using NMR (Bruker 400 Ultrashield with Icon NMR analysis software). Deviations of the characterization and performance results were obtained by testing 3 samples of the same type of the dual-layer membrane or free-standing membrane.

### Example 3a Enhancement of PV Separation Performance and Long Term Stability when Using MXene as the Nanofiller

PV desalination at 30° C. using 0.6 M (3.5 wt %) NaCl solution was performed on PVA/PTFE, PS/PTFE and PSM/PTFE dual-layer membranes as presented in FIG. 6. The water trans-membrane flux was gradually elevated by the incorporation of SSA and subsequent MXene nanosheets, increasing from 17.5 kg m⁻² h⁻¹ (PVA/PTFE) to 45.7 (PS/PTFE) and 62.2 kg ⁻² h⁻¹ (PSM/PTFE). That was equivalent of 1.6- and 2.6-fold enhancements of water permeation flux, respectively. In addition, the PS/PTFE and PSM/PTFE exhibited almost complete salt rejection (99.8%) whereas the PVA/PTFE shows lower salt rejection. Compared with PS/PTFE, MXene imparted the dual-layer PSM/PTFE membrane with even higher water permeation flux because of a combination of factors such as more amorphous region, increased free volume pore size, higher FFV and potentially additional permeating paths through MXene or MXene-polymer interphase. Advantageously, PSM exhibited a more hydrophilic surface than PS. That indicated a higher concentration of water adsorbed on the membrane surface, causing a greater concentration gradient across the membrane and thus the corresponding driving force for molecule permeation.

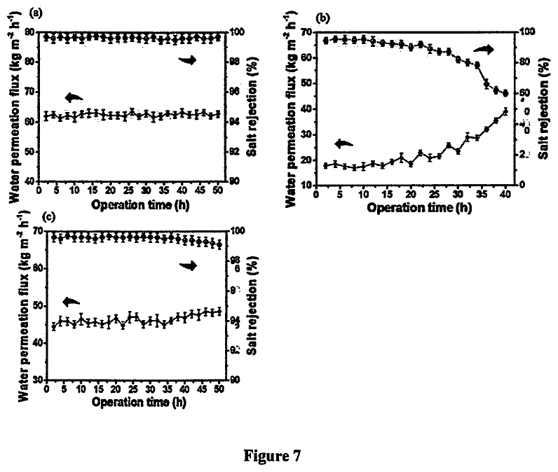

The selectivity and stability of membrane are highly susceptible to polymer chain mobility. Penetrating solutes such as water can exert solvating effect or plasticization on polymer, disrupting the interchain interactions and thereby enhancing the permeation of undesired solutes. Tailoring the interfacial interactions to restrain polymer structural relaxation while creating more free volume, as occurred on incorporation of MXene demonstrated an effective strategy to bestow the PSM with excellent separation property and stability. To further verify that, long-term tests (50 h) were conducted as shown in FIG. 7. The dual-layer PSM/PTFE membrane maintained a more stable throughput without attenuation in molecule separation throughout the long-term operation, advantageously providing mechanically robust and structurally stable separating dual-layer membrane under continuous operation. By contrast, the water permeation flux of PVA/PTFE dual-layer membrane increased with time whilst its salt rejection declined, possibly because of the impermanent structural configuration brought about by plasticization of polymer chains and dissolution of crystallites, thus damaging the integrity and thus separation performance. Crosslinking rendered the PVA network of PS/PTFE dual-layer membrane insoluble in water, resulting in an evident improvement of stability with decreased performance emerging after 35 h.

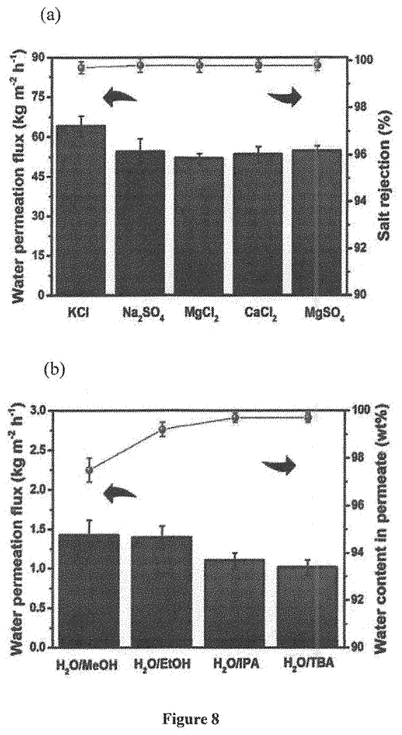

Since the PSM/PTFE dual-layer membrane exhibited superior separation performance to PVA/PTFE and PS/PTFE, its molecule separation properties were further probed by pervaporative separations of water from various aqueous ion or alcohol solutions. In FIG. 8a, the desalination performances toward various salt solutions are presented. The PSM/PTFE dual-layer membrane was herein presented to exhibit outstanding separation performances with salt rejections all above 99.8%. With increased solvated ion radii, hydration number and total concentrations of ions (Table 2), free water molecules that would be dissolved on the membrane surface were suspected to decrease, which influenced the total trans-membrane flux.

TABLE 2
Hydrated ion sizes and ion concentration of 0.6M salt solution.

| | | Bare | | Hydrated | Ion |
|---|---|---|---|---|---|
| | | ion radius | Hydration | ion sizes | conc. |
| Salts | Ions | (nm) | no. | (nm) | (M) |
| KCl | K⁺ | 0.134 | 5.7 | 0.66 | 0.6 |
| | Cl⁻ | 0.183 | 5.3 | 0.66 | 0.6 |
| Na₂SO₄ | Na⁺ | 0.098 | 6.5 | 0.72 | 1.2 |
| | SO₄²⁻ | 0.24 | 3.9 | 0.76 | 0.6 |
| MgCl₂ | Mg²⁺ | 0.072 | 11.7 | 0.86 | 0.6 |
| | Cl⁻ | 0.183 | 5.3 | 0.66 | 1.2 |
| CaCl₂ | Ca²⁺ | 0.103 | 10.4 | 0.82 | 0.6 |
| | Cl⁻ | 0.183 | 5.3 | 0.66 | 1.2 |
| MgSO₄ | Mg²⁺ | 0.072 | 11.7 | 0.86 | 0.6 |
| | Cl⁻ | 0.183 | 5.3 | 0.66 | 0.6 |

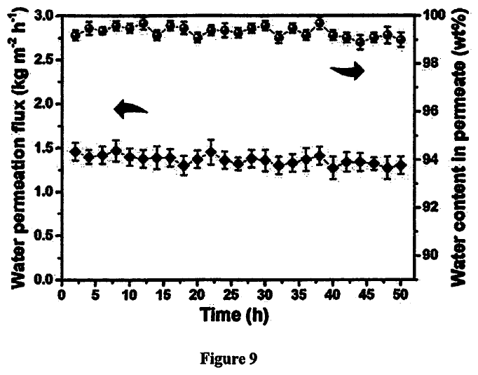

Further, dehydration of 96 wt % alcohol-4 wt % water binary mixtures, which is representative of a necessary step in industrial alcohol processing, was carried out at 30° C. (FIG. 8b). The C1 to C4 alcohols were readily held back whereas high purity of water in the permeate stream was obtained, i.e., 97.6 (methanol/H₂O), 99.5 (ethanol/H₂O), 99.7 (propanol/H₂O) and 99.9 (butanol/H₂O) wt %. That resulted in the separation factors of 968, 4738, 7913 and 23786, respectively. Similarly, the sizes of alcohol molecules played a role in effecting the water permeation flux as occurred in the desalination process. Long-term dehydration of ethanol was also conducted to further assess the durability of PSM/PTFE dual-layer membrane. As shown in FIG. 9, the water permeation flux was slightly decreased from 1.46 to 1.31 kg ⁻² h⁻¹ during the 50 h operation. The corresponding water content in the permeate side maintained relatively steady in the range of 99.5 to 99 wt %. Such stable separation performance in severe solvent environment coincided with that of long-term desalination, further proving the high performance and structural stability.

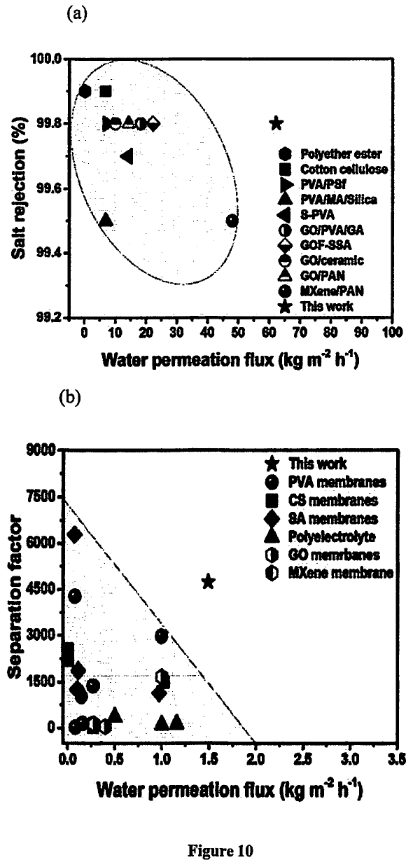

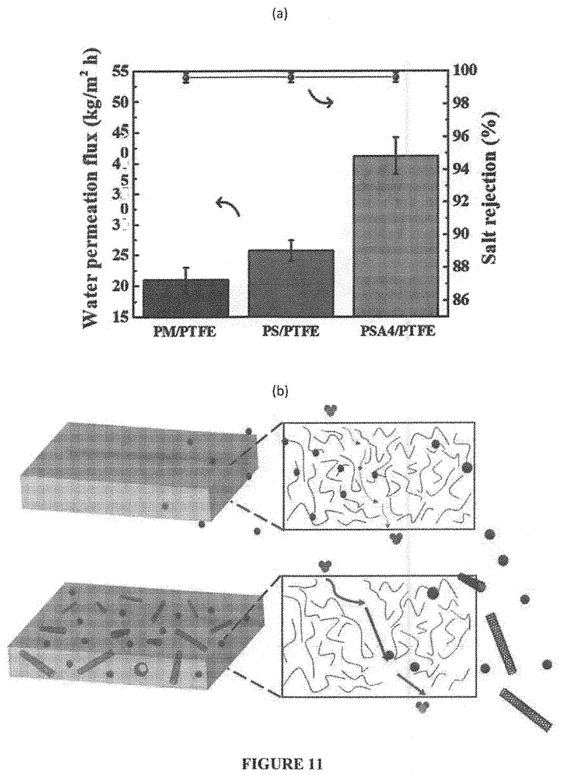

By comparing the separation performance with other reported membranes in PV desalination or alcohol dehydration (FIGS. 10a and b), the PSM/PTFE dual-layer membrane exhibited notably higher water permeation flux without compromising separation efficiency, placing it in a region away from the intrinsic capability of those state-of-the-art membranes (in the colored realm). Particularly for desalination, the water permeation flux was even 8.41, 4.35 and 1.29 folds of PVA/PSf (100-nm-thick maleic acid crosslinked PVA active layer), GO/PAN and MXene/PAN, respectively. As opposed to those hydrophilic substrates used in previously reported PV composite membranes, the porous PTFE hydrophobic substrate as described here was hydrophobic that therefore only allowed transport of water vapor rather than liquid flow. Hence it was reasonable to infer that the PV by PSM/PTFE membrane with such Janus property combined with the solution-diffusion process of the PSM layer and fast vapor transport through PTFE substrate layer that benefited the overall mass transport through the composite membrane. Detailed information of ethanol dehydration comparison is shown in Table 3.

TABLE 3
Comparison of the ethanol dehydration
using pervaporation membranes

| | | Feed | Water | |
|---|---|---|---|---|
| | Temp./ | (ethanol | flux/kg | Separation |
| Membrane | ° C. | wt %) | m⁻² h⁻¹ | factor |
| PVA | 40 | 90 | 0.280 | 104 |
| PVA/silk fibroin | 22 | 70 | 0.08 | 23.7 |
| PVA/ZIF-90 | 30 | 90 | 0.268 | 1379 |
| PVA/Fe-DA | 30 | 90 | 0.995 | 2980 |
| PVA/SiO₂ | 40 | 85 | 0.145 | 1026 |
| PVA/ZIF-8-NH₂ | 40 | 85 | 0.158 | 148 |
| PVA/GO | 45 | 95 | 0.074 | 4281 |
| POSS/CS | 60 | 90 | 0.270 | 30 |
| CS/MXene | 50 | 90 | 1.42 | 1421 |
| CS/Fe₃O₄ | 77 | 90 | 1.24 | 1500 |
| CS | 40 | 96 | 0.004 | 2208 |
| CS/acetate salt | 40 | 96 | 0.002 | 2556 |
| SA/PEI-PDA/PAN | 30 | 96 | 0.07 | 6291 |
| SAMA | 30 | 90 | 0.111 | 1866 |
| SA/PVP/PWA | 27 | 90 | 0.1 | 1250 |
| HA/SA/PAN | 80 | 90 | 0.9 | 1130 |
| Nexar ™/PEI | 50 | 85 | 1.16 | 127 |
| PAA/PEI/PAN | 50 | 85 | 1 | 100 |
| PAA/PEI/PES | 40 | 85 | 0.5 | 350 |
| GO/GTA | 25 | 85 | 0.28 | 125 |
| GO | 24 | 85 | 0.4 | 40 |
| rGO | 70 | 50 | 1 | 1665 |
| MXene | 25 | 95 | 0.263 | 135.2 |
| PSM/PTFE | 30 | 96 | 1.489 | 4738 |

### Example 3b Enhancement of PV Separation Performance and Long Term Stability when Using CNT as the Nanofiller

In FIG. 11a, the membrane performances were evaluated by pervaporation desalination of aqueous NaCl solution (3.5 wt %) at feed temperature of 30° C. and 130 Pa permeate pressure. Membranes containing either maleic acid (MA) or sulfosuccinic acid (SSA) (i.e., PM and PS) exhibited good separation properties with high salt rejection values over 99.7%, which could be attributed to essential crosslinking of polymer chains, thus ensuring anti-swelling behavior and desired selectivity of water from the aqueous ion mixture. The incorporation of acid-treated CNTs (ACNT4) as occurred in PSA4 was able to retain high separation efficiency as those of PM and PS. That was assumed to be related to the uniform dispersion state of functionalized CNTs in the crosslinked polymer matrix.

Water permeation fluxes for PM, PS and PSA4 were 21.1, 25.7 and 41.5 kg/m² h respectively, showing an upward trend after the addition of sulfonic acid groups and chemically modified CNTs.

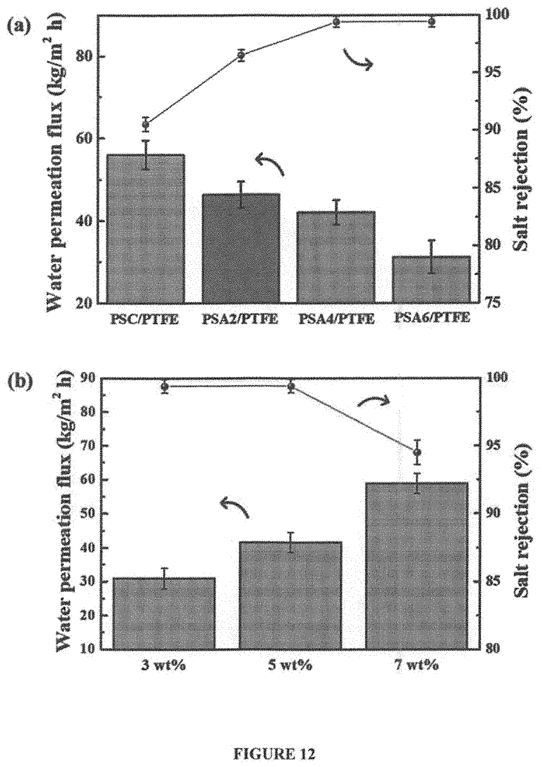

Water permeation fluxes and salt rejection values from a series of CNT incorporated PVA FTMs are shown in FIG. 12a (5 wt % CNT relative to PVA). These membranes were prepared by using CNTs with different acid-treatment time and pristine CNT (as the control sample). With the incorporation of ACNT4, PSA4 exhibited remarkable 1.6-fold value of water flux with respect to PS.

It has been found that there is an optimized nanofiller-to-polymer ratio for organic-inorganic hybrid membrane to provide maximized water permeation flux and salt rejection. As shown in FIG. 12b, the water permeation flux increased with ACNT content, suggesting CNT mediated transport occurred in the membrane. Salt rejection values for the membranes containing 3 wt % of ACNTs and 5 wt % of ACNTs exhibited good salt rejection without losing water permeation flux, reasonably as a result of the uniform dispersion state of ACNTs.

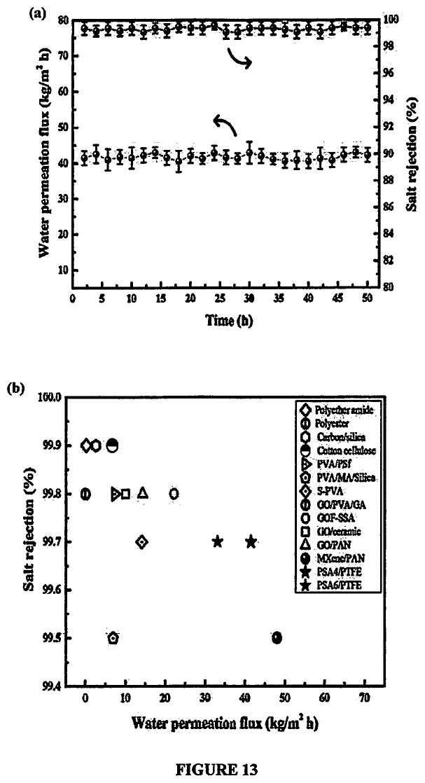

The long term performance of PSA4 was examined. Over 50 h pervaporation desalination operation using 3.5% NaCl solution as the feed (FIG. 13a), the membrane maintained stable performance with high water permeation flux 40.4-42.7 kg/m² h, as well as a high salt rejection of over 99.1%, showing good performance stability which is required for practical application. This excellent membrane integrity is attributed to the incorporation of CNT as nanofiller and crosslinking of PVA with SSA.

FIG. 13b summarizes the desalination performance of typical PV membranes synthesized from various materials, including polymer, inorganic nanosheets and organic-inorganic hybrids. Under similar operating conditions such as feed temperature (22-30° C.), downstream pressure (100-130 Pa) and feed concentration (2,000-35,000 ppm), the PSA membrane exhibited excellent salt rejection with notably higher water throughput compared with other polymeric and graphene oxide (GO) based membranes. For example, PSA4 exhibited water permeation flux ˜2.9 times greater than PVA/4-sulfophthalic acid/polyacrylonitrile (PAN) FTM (sulfonic acid groups as transport carriers) and 2 times SSA crosslinked graphene oxide membrane. In addition to the high performance separating layer based on PVA/SSA/ACNTs, it has also been unexpectedly found that the hydrophobic PTFE/PP support layer with inherent low friction resistance may contribute to faster water transport when compared with those composite membranes containing hydrophilic support substrates.

### Example 4 Dual Layer Membranes Containing MOF or GO as Nanofiller for Membrane Distillation (ND)

In this example, the dual-layer membrane composed of the thin nanoporous hydrophilic layer on a microporous hydrophobic substrate are investigated for desalination and wastewater treatment in a membrane distillation (MD).

A series of membranes using the metal organic framework (MOF) aluminium fumarate (AlFu) or graphene oxide (GO) as the nanofiller in the nanoporous hydrophilic layer were prepared to investigate the anti-wetting property of the dual-layer membranes following the method for preparing a dual-layer membrane as described by Example 1 and 2 above.

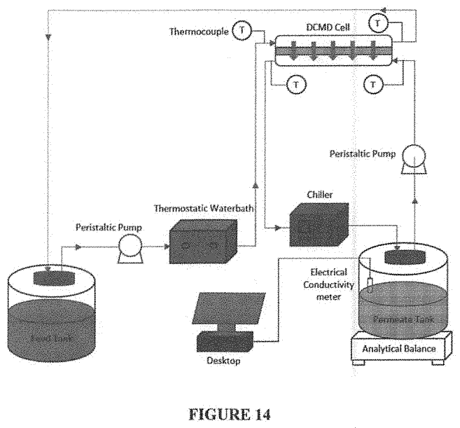

A direct-contact MD (DCMD) experimental set-up was used for the membrane testing (FIG. 14). The flat sheet membrane cells made of acrylic plastics can minimize the heat loss to surroundings. The flow channels of the feed and permeate semi-cells were engraved in each of two acrylic blocks with an effective membrane surface area of 26 cm². Two variable-speed peristaltic pumps (with the same flow controller) were used to circulate the feed and permeate through the membrane cell with the same flow rates of 500 ml/min. Polypropylene spacer (thickness of 0.75 mm) were used in both feed and permeate side to guide the flow and improve flow turbulence. The feed and permeate temperatures were adjusted by a heater integrated water bath and a chiller, respectively. The temperatures at the inlet and outlet of the membrane module on both feed and permeate side were measured by K-type thermocouples with ±1° C. accuracy. The temperature at feed and permeate side were controlled at 50° C. and 10° C. respectively. The feed was directly contacted with the hydrophilic layer side of the dual layer membrane in DCMD experiment. The penetration of solute was measured depending on the conductivity measurement of the permeate solution with a digital conductivity meter (model no: HI98198 supplied by Hanna Instruments). The weight increment of the permeate was determined by a digital balance. The water permeate flux, J (kg/(m²·h)) was derived from the mass (Mi) of permeate collected on the permeate side over the effective membrane separating area (A) and the operation time (t).

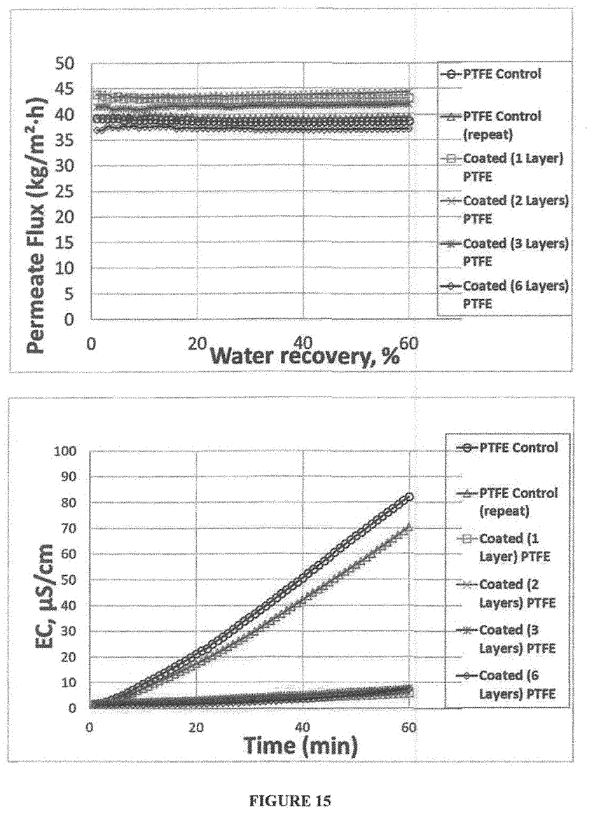

Table 3 shows the performance of the dual-layer membranes for membrane distillation (MD) on permeate flux as the membrane thickness was increased by increasing the number of nanoporous hydrophilic layers supported by the microporous hydrophobic substrate. The content of cross-linking agent was maintained at 20 wt % (SSA) for each layer and a solution of 3.5 wt % NaCl and 0.4 mM SDS was used as the feed. All variations of the dual membranes demonstrated high salt rejection>99% and achieved high water flux during MD process as show in FIG. 15.

TABLE 3
Performance of the dual-layer membranes on permeate flux
with varied nanoporous hydrophilic layer thickness

| | Direction of | | Permeate Flux |
|---|---|---|---|
| Dual-layer membrane | water flow | Heat Treatment | (kg/m² · h) |
| PTFE control | With same direction of | 80° C. for 1 hour | 38.50 |
| | longer dimension of | | |
| | the texture - (Longer) | | |
| PTFE control (repeat) | Longer | 80° C. for 1 hour | 39.27 |
| PVA + 20% SSA on PFTE (1 layer) | Shorter | 80° C. for 1 hour | 42.88 |
| PVA + 20% SSA on PFTE (2 layers) | Shorter | 80° C. for 1 hour | 44.08 |
| PVA + 20% SSA on PFTE (3 layers) | Shorter | 80° C. for 1 hour | 41.81 |
| PVA + 20% SSA on PFTE (6 layers) | Longer | 80° C. for 1 hour | 36.92 |

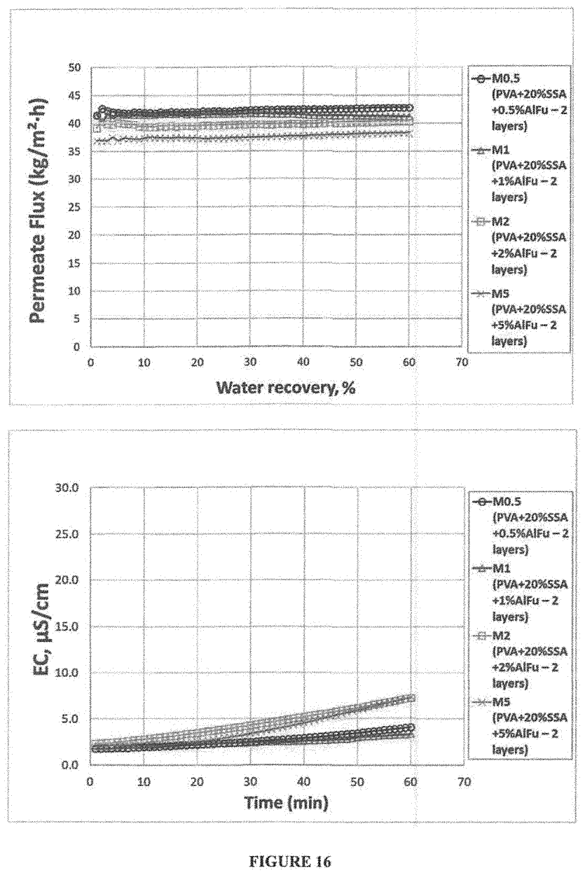

Table 4 shows the performance of the dual-layer membranes for membrane distillation (MD) on permeate flux. The dual-layer membranes comprised two layers of nanophorous hydrophilic layer supported on a microporous hydrophobic substrate where the content of cross-linking agent was maintained at 20 wt % (SSA or MA) for each layer and the concentration of nanofiller was varied between 0.1 to 5 wt % of aluminium fumurate (AlFu) MOF. A solution of 3.5 wt % NaCl and 0.4 mM SDS was used as the feed. All variations of the dual-membranes demonstrated high salt rejection>99% and achieved high water flux during MD process as shown in FIG. 16.

TABLE 4
Performance of the dual-layer membranes on permeate
flux with concentration of the nanofiller varied

| | Direction of | | Permeate Flux |
|---|---|---|---|
| Dual-layer membrane | water flow | Heat Treatment | (kg/m² · h) |
| PVA + 20% SSA + 0.1% AlFu on PTFE | Longer | 80° C. for 1 hour | 41.46 |
| PVA + 20% SSA + 0.5% AlFu on PTFE | Shorter | 80° C. for 1 hour | 41.96 |
| PVA + 20% SSA + 1% AlFu on PTFE | Shorter | 80° C. for 1 hour | 41.50 |
| PVA + 20% SSA + 2% AlFu on PTFE | Shorter | 80° C. for 1 hour | 41.08 |
| PVA + 20% SSA + 5% AlFu on PTFE | Shorter | 80° C. for 1 hour | 40.38 |
| PVA + 20% MA + 0.1% AlFu on PTFE | Longer | 80° C. for 1 hour | 39.73 |
| PVA + 20% MA + 0.5% AlFu on PTFE | Longer | 80° C. for 1 hour | 40.54 |
| PVA + 20% MA + 1% AlFu on PTFE | Longer | 80° C. for 1 hour | 41.46 |
| PVA + 20% MA + 5% AlFu on PTFE | Longer | 80° C. for 1 hour | 40.77 |

Table 5 shows the performance of the dual-layer membranes for membrane distillation (MD) on permeate flux. The dual-layer membranes comprised two layers of nanophorous hydrophilic layer supported on a microporous hydrophobic substrate where the content of cross-linking agent was maintained at 20 wt % (SSA or MA) for each layer and the concentration of nanofiller was varied between 0.1 to 5 wt % of aluminium fumurate (AlFu) MOF or graphene oxide (GO). A solution of 3.5 wt % NaCl and 0.4 mM SDS was used as the feed. All variations of the dual-membranes demonstrated high salt rejection>99% and achieved high water flux during MD process as shown in Table 5.

TABLE 5
Performance of the dual-layer membranes on permeate flux with
concentration of the nanofiller (AlFu MOF or GO) varied

| | Direction of | | Permeate Flux |
|---|---|---|---|
| Dual-layer membrane | water flow | Heat Treatment | (kg/m² · h) |
| PVA + 20% MA on PTFE | Shorter | 120° C. for 2 hours | 42.92 |
| PVA + 20% SSA on PTFE | Shorter | 120° C. for 2 hours | 42.85 |
| PVA + 20% MA + 0.1% GO on PTFE | Shorter | 120° C. for 2 hours | 37.08 |
| PVA + 20% MA + 0.1% AlFu on PTFE | Shorter | 120° C. for 2 hours | 39.38 |
| PVA + 20% SSA + 0.1% GO on PTFE | Shorter | 120° C. for 2 hours | 39.85 |
| PVA + 20% SSA + 0.1% AlFu on PTFE | Shorter | 120° C. for 2 hours | 39.15 |
| PVA + 0.1% GO on PTFE | Shorter | 120° C. for 2 hours | 42.31 |
| PVA + 0.1% AlFu on PTFE | Shorter | 120° C. for 2 hours | 37.62 |
| PVA + 20% MA on PTFE (adjust pH to 1.7 using | Shorter | 120° C. for 2 hours | 42.00 |
| HCl) | | | |
| PVA + 20% MA + 0.1% GO on PTFE (adjust pH | Shorter | 120° C. for 2 hours | 40.46 |
| to 1.7 using HCl) | | | |
| PVA + 20% MA + 0.1% AlFu on PTFE (adjust pH | Shorter | 120° C. for 2 hours | 40.46 |
| to 1.7 using HCl) | | | |

As can be seen from the performance testing, the permeate flux could be maintained or increased by having thin hydrophilic layer on hydrophobic microporous substrate as shown in FIG. 14. The permeate flux surprisingly increased by approximately 13% when the PTFE membrane supported two layers of a nanoporous hydrophilic layer comprising PVA-20 wt % SSA. More importantly, the dual layer membranes advantageously show significantly increased the anti-wetting property (FIGS. 15 and 16).

### Example 4a Surface Wettability

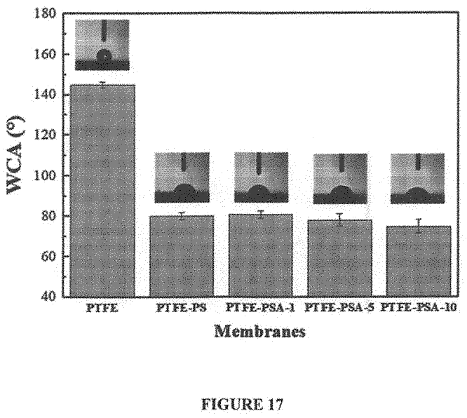

The hydrophobic-hydrophilic property of the prepared MD membrane surfaces were quantified by water contact angle (WCA) measurements with images of a water droplet on the corresponding membrane as measured. The WCA for PTFE membrane was 144.7° due to its low surface energy (FIG. 17). Upon the attachment of the PVA based mixed matrix layer on the PTFE, the fabricated dual-layer composite membranes exhibited hydrophilic surfaces with values of 80.1°, 80.8°, 78° and 74.7° for PTFE-PS, PTFE-PSA-1, PTFE-PSA-5 and PTFE-PSA-10, respectively (see FIG. 17). The hydrophilic properties of the dual layer membrane surfaces were attributed to the contact between the uppermost PVA based layers and water molecules. Furthermore, it can be seen that the surfaces could be turned to be more hydrophilic with the increase of AlFu MOF loading. This may have originated from the additional hydrophilic groups provided by outmost AlFu MOF on the surface of the PVA based layers. Overall, the WCA results confirmed the hydrophilic-hydrophobic structure of the dual-layer membranes, demonstrating an altered surface wetting property compared to the pristine PTFE membrane.

### Example 4b Antiwetting Properly

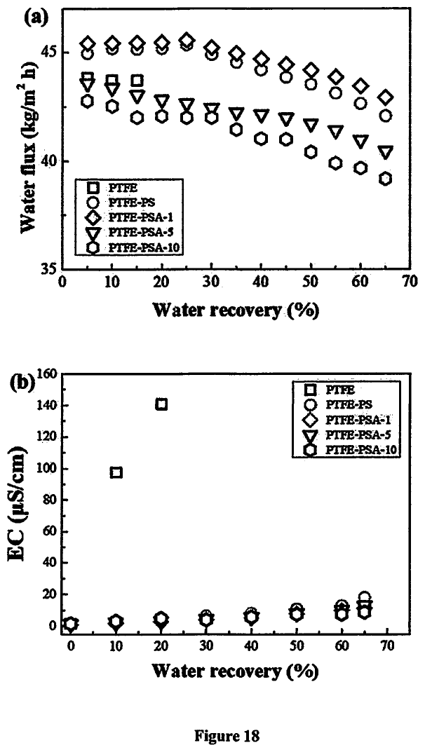

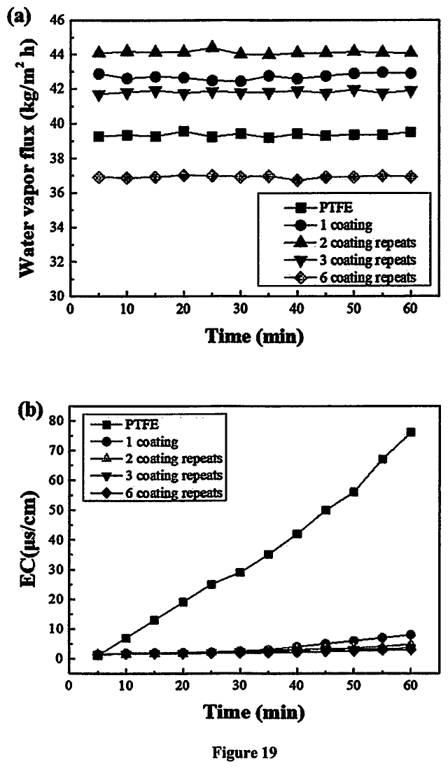

The PTFE and dual-layer membranes were subjected to the DCMD processes using aqueous solutions containing NaCl and SDS to evaluate the effect of the additional hydrophilic layer on the antiwetting property. The water flux and EC in the permeate relative to water recovery are shown in FIG. 18. For the PTFE membrane, wetting phenomenon was immediately observable with continuous increase of EC of the permeate stream even at low water recovery (20%). Compared to the PTFE membrane, all the dual-layer membranes exhibited significantly enhanced wetting resistance. There was slight water flux decline with the increased water recovery that could be attributed to the increase in salt and SDS concentrations in the feed, reducing the contact between feed water and the membrane surface. At 65% water recovery, the EC in the permeate side of the dual-layer membranes was only increased marginally from ˜1.5 uS/cm to less than 17.1 uS/cm, still maintaining very high salt rejection. In addition, with the increase in the casting repeats (FIG. 19), the dual-layer membranes exhibited decreased water vapor flux due to the increase in the thickness of the dense hydrophilic layer while the antiwetting property was enhanced compared with the bare PTFE membrane.

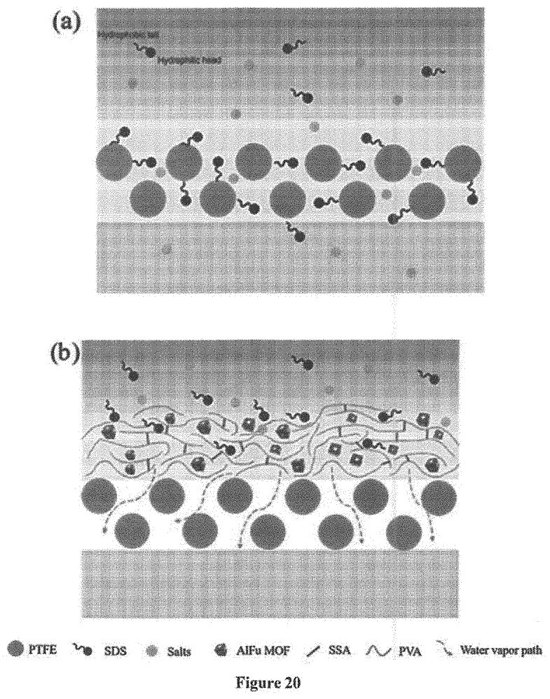

Compared to the surface tension of water (72.66 mN/m at 25° C.), the presence of amphiphilic SDS molecules in solution lowered the surface tension of the solution to 64.89 mN/m at 25° C. (40 mg/L). That is conducive to reducing the hydraulic transmembrane pressure through the hydrophobic pores. More importantly, the hydrophobic tails of SDS tend to form hydrophobic-hydrophobic interactions with PTFE, leading to the adhesion on the membrane surface and pore surface as depicted in FIG. 20. As a result, the hydrophilic head of SDS allows the intrusion of the saline solution, leading to the membrane wetting phenomenon (FIG. 20a). On the other hand, the hydrophilic layers on the dual-layer membranes are free of hydrophobic interactions as occurred for the PTFE membrane. The main mechanism for enhancing the antiwetting property is the ability to prevent the PTFE layer from contacting the surfactant but allow water transport. As illustrated in FIG. 20b, it is assumed that the PVA based hydrophilic layer rendered a selective water path to the evaporation region while effectively reducing the permeation rate of SDS due to the existence of hydrophobic entity. When the water molecules penetrated to the evaporation region, they effectively evaporated and the vapor transported through the hydrophobic pores whereas SDS molecules hardly permeated PVA coating and were rejected.

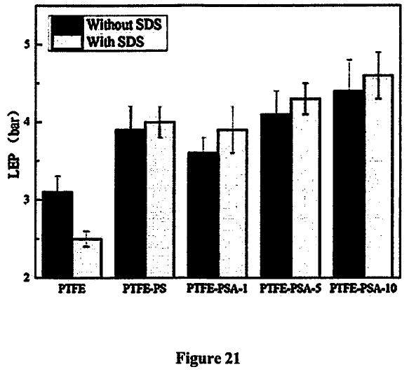

Liquid entry pressure (LEP) tests were carried out by placing a dry membrane sample in a cylindrical pressure filtration cell (connected to a compressed air cylinder) and pressurizing deionized water or SDS-containing (0.04 mM) solution. The pressure was increased stepwise (0.5 bar/5 min) until the first liquid droplet of the feed was observed in permeate side whereby the pressure value was determined as the LEP. In order to further verify this proposition, LEP tests using water and SDS solutions were conducted. As shown in FIG. 21, all dual-layer membranes exhibited higher LEP than PTFE membrane despite a significantly enhanced hydrophilicity of the membrane surface. These results are supported by permeation through the PVA based dense layer, giving rise to an additional barrier effect for water to transport through the membrane. Furthermore, when SDS was added in the liquid, the LEP for PTFE membrane was obviously reduced from 3.1 to 2.6 bar whereas LEPs for the dual-layer membranes all increased. These results indicated the SDS permeation in the membranes added extra resistance compared to that of water molecules. When the SDS molecules permeating in the membrane with hydrophobic tails pointed to the water phase, that would increase the difficulty of the water to pass through the membrane. In addition, the anionic repulsion between sulfate groups (SDS) and sulfonic acid groups (SSA) could inevitably increase the energy requirement for SDS permeation. Last, the distribution of hydrophilic MOF within the polymer matrix might exert increased transport resistance for SDS towards its hydrophobic tails.

### Example 4c Real Seawater Desalination

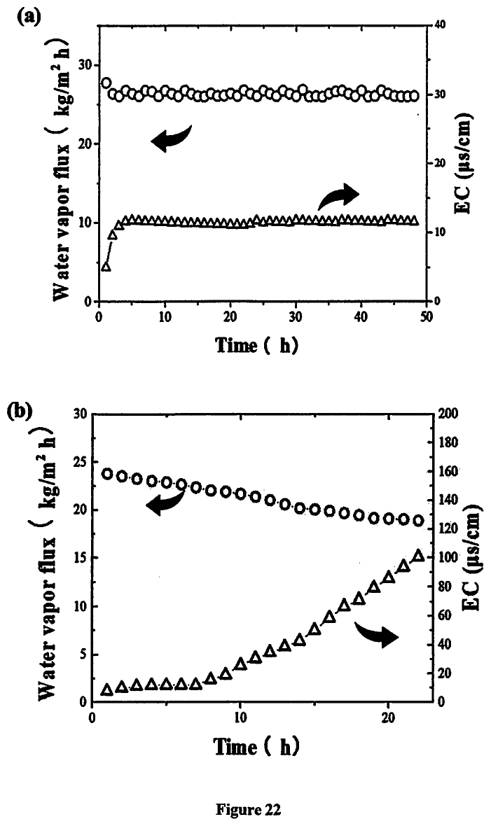

Real seawater desalination testing was performed on the PTFE-PSA-1 membrane. The seawater was collected from black rock (Melbourne, Vic, Australia) and used as the feed without pre-treatment. As shown in FIG. 22a, the water vapour flux and salt rejection of the PTFE membrane declined with processing time due to potential organic fouling and membrane wetting. The PTFE membrane failed to continue longer time than 23 h. Comparatively, the PTFE-PSA-1 membrane exhibited higher water vapor flux (˜25.3 kg/m² h) while with salt rejection of 99.9% and long-term stability over 48 h due to the hydrophilic membrane surface with enhanced antiwetting property and water selective permeation. Furthermore, for the AlFu-MOF, their fixation in the polymer matrix was essential for the stable performance in terms of a material property. The PTFE-PSA-1 membrane was immersed in DI water for 100 h followed by analysis of the soak solution by ICP. No Al was detected in the soak solution, demonstrating no leaching of MOF from the polymer matrix.

Overall, provided herein are enhanced dual-layer membrane designs with adjustable throughput and enhanced antiwetting property, which is promising to achieve high-performance MD application

1. A membrane comprising a nanoporous hydrophilic layer supported on a porous hydrophobic substrate, wherein the pore size of the hydrophilic layer is less than about 10 nm, and wherein the nanoporous hydrophilic layer comprises a nanofiller selected from the group comprising MXene, a carbon based nanomaterial, a MOF, or a silica nanoparticle.

2. The membrane of claim 1, wherein the nanoporous hydrophilic layer comprises a hydrophilic polymer

3. The membrane of claim 2, wherein the hydrophilic polymer is polyvinyl alcohol.

4. The membrane of claim 2 or 3, wherein the content of the hydrophilic polymer in the nanoporous hydrophilic layer is between about 50% and 99% by weight of the nanoporous hydrophilic layer.

5. The membrane of any one of claims 1 to 4, wherein the nanoporous hydrophilic layer comprises a crosslinking agent.

6. The membrane claim 5, wherein the crosslinking agent is a sulphonated crosslinking agent selected from the group comprising sulfosuccinic acid, 4-sulfophthalic acid, 4,6-disulphoisophthalic acid, glutaraldehyde, maleic acid, oxalic acid, fumaric acid, toluene di-isocyanate, citric acid, or combinations thereof.

7. The membrane of claim 5 or 6, wherein the content of the crosslinking agent is between about 1% and 30% by weight of the nanoporous hydrophilic layer.

8. The membrane of any one of the preceding claims, wherein the MXene has the general formula Mₙ₊₁XₙTₓ; M is selected from the group comprising Ti, Zr, V, Nb, Ta, or Mo; T is selected from the group comprising O, F, OH or Cl; X is selected from C or N; and, n and x are independently selected from 1, 2, 3 or 4.

9. The membrane of any one of the preceding claims, wherein the content of the nanofiller in the nanoporous hydrophilic layer is between 0.1% and 30% by weight of the nanoporous hydrophilic layer.

10. The membrane of any one of the preceding claims, wherein the thickness of the nanoporous hydrophilic layer is between about 100 nm and 700 nm.

11. The membrane of any one of the preceding claims, wherein the thickness of the nanoporous hydrophilic layer is between about 100 nm and 300 nm.

12. The membrane of any one of the preceding claims, wherein the porous hydrophobic substrate comprises a polymeric material selected from the group comprising polytetrafluoroethylene (PTFE), polypropylene (PP), polyvinylidene fluoride (PVDF), poly-(vinylidene difluoride-hexafluoropropylene copolymer) (PVDF-co-HFP), or acrylic copolymer.

13. The membrane of any one of the preceding claims, wherein the pore size distribution of the hydrophobic substrate is in a range between 0.1 μm and 5 μm.

14. A process for preparing a membrane comprising a nanoporous hydrophilic layer supported on a porous hydrophobic substrate, wherein the pore size of the hydrophilic layer is less than about 10 nm, the process comprising the steps of:
(i) preparing an aqueous hydrophilic casting solution comprising a hydrophilic polymer, a crosslinking agent, a nanofiller, and a solvent system;
(ii) casting a layer of the aqueous hydrophilic casting solution onto a porous hydrophobic substrate to provide a wet hydrophilic layer supported on the porous hydrophobic substrate;
wherein the nanofiller is selected from the group comprising a MXene, a carbon based nanomaterial, a MOF, or a silica nanoparticle.

15. The process according to claim 14, wherein the process further comprises step (iii) solidifying the wet hydrophilic layer by (a) solvent evaporation and/or (b) heat treatment to provide a dry hydrophilic layer supported on the porous hydrophobic substrate.

16. The process according to claim 14 or claim 15, wherein the content of crosslinking agent in the aqueous hydrophilic casting solution is between about 1% and 30% by weight of the total content of the hydrophilic polymer.

17. The process according to any one of claims 14 to 16, wherein the concentration of nanofiller in the aqueous hydrophilic casting solution is between about 0.1% and 30% by weight of the total content of the hydrophilic polymer.

18. The process according to any one of claims 14 to 17, wherein the viscosity of the aqueous hydrophilic casting solution is in a range between 10 mPas and 2000 mPas

19. The process according to any one of claims 14 to 18, wherein the thickness of the wet hydrophilic layer is in a range between about 4 and 100 μm.

20. The process according to claim 19, wherein the thickness of the wet hydrophilic layer is about 50 μm.

21. The process according to any one of claims 14 to 20, wherein the thickness of the dry hydrophilic layer is in a range between about 100 and 700 nm.

22. The process according to any one of claims 15 to 21, wherein the temperature for step (iii)(a) is between about 20° C. and 40° C.

23. The process according to claim 22, wherein the wet hydrophilic layer is maintained at the temperature of step (iii)(a) for about 30 minutes to 48 hours.

24. The process according to any one of claims 15 to 23, wherein the temperature for step (iii)(b) is between about 70° C. and 160° C.

25. The process according to claim 24, wherein the dry hydrophilic layer is maintained at the temperature of step (iii)(b) for about 5 minutes to 360 hours.

26. The process according to any one of claims 14 to 25, wherein the hydrophilic polymer is polyvinyl alcohol.

27. The process according to any one of claims 14 to 26, wherein the porous hydrophobic substrate comprises a polymeric material selected from the group comprising polytetrafluoroethylene (PTFE), polypropylene (PP), polyvinylidene fluoride (PVDF), poly-(vinylidene difluoride-hexafluoropropylene copolymer) (PVDF-co-HFP), or acrylic copolymer

28. A membrane comprising a nanoporous hydrophilic layer supported on a porous hydrophobic substrate prepared by the process as defined by any one of claims 14 to 27.

29. Use of a membrane comprising a nanoporous hydrophilic layer supported on a porous hydrophobic substrate for separation of water from aqueous-ion mixtures, wherein the pore size of the hydrophilic layer is less than about 10 nm, and wherein the nanoporous hydrophilic layer comprises a nanofiller selected from the group comprising MXene, a carbon based nanomaterial, a MOF, or a silica nanoparticle.

30. The use according to claim 29, wherein the membrane comprises a nanoporous hydrophilic layer supported on a porous hydrophobic substrate as defined by any one of claims 1 to 13, or prepared by the process defined by any one of claims 14 to 27.

31. Use of a membrane comprising a nanoporous hydrophilic layer supported on a porous hydrophobic substrate for separation of water from alcohol mixtures, wherein the pore size of the hydrophilic layer is less than about 10 nm, and wherein the nanoporous hydrophilic layer comprises a nanofiller selected from the group comprising MXene, a carbon based nanomaterial, a MOF, or a silica nanoparticle.

32. The use according to claim 31, wherein the membrane comprises a nanoporous hydrophilic layer supported on a porous hydrophobic substrate as defined by any one of claims 1 to 13, or prepared by the process defined by any one of claims 14 to 27.

33. Use of a membrane comprising a nanoporous hydrophilic layer supported on a porous hydrophobic substrate, wherein the membrane can be used in combination with reverse osmosis treatment, wherein the pore size of the hydrophilic layer is less than about 10 nm, and wherein the nanoporous hydrophilic layer comprises a nanofiller selected from the group comprising MXene, a carbon based nanomaterial, a MOF, or a silica nanoparticle.

34. The use according to claim 33, wherein the membrane comprises a nanoporous hydrophilic layer supported on a porous hydrophobic substrate as defined by any one of claims 1 to 13, or prepared by the process defined by any one of claims 14 to 27.
